(19) United States
(12) Patent Application Publication
(10) Pub. No.: US 2008/0197070 A1
(43) Pub. Date: Aug. 21, 2008

(54) Composite Membranes and Membrane Systems and Methods For Production and Utilization Thereof

(75) Inventors: Kamalesh K. Sirkar, Bridgewater, NJ (US); Alexander P. Korikov, Port Washington, NY (US); Praveen B. Kosaraju, Wilmington, DE (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: NEW JERSEY INSTITUTE OF TECHNOLOGY, Newark, NJ (US)

(21) Appl. No.: 11/929,155

(22) Filed: Oct. 30, 2007

Related U.S. Application Data
(60) Provisional application No. 60/855,259, filed on Oct. 30, 2006.

(51) Int. Cl. B01D 39/16; B05D 3/10

(52) U.S. Cl. 210/500.27; 427/301

(57) ABSTRACT

Thin film composite membranes on polyolefin structures may be prepared by interfacial polymerization on a polyolefin support. Polyolefin structures may have hollow and/or solid portions. The polyolefin structure may be hydrophilized prior to interfacial polymerization. The hydrophilized structure may also be treated with an aqueous monomer containing solution first, followed by the organic monomer containing solution. Alternatively, an organic monomer solution may be introduced first, followed by the aqueous monomer containing solution when treating a hydrophilized structure. The formed membrane may possess advantageous characteristics, including stability, hydrophilicity, predetermined pore sizes and/or solvent resistance.

### CROSS-REFERENCE TO RELATED APPLICATION

The present application claims the benefit of a co-pending, commonly assigned provisional patent application entitled “System and Method of Preparation of Thin Film Composite Membrane Based on Hydrophobic Support Membrane,” which was filed on Oct. 30, 2006, and assigned Ser. No. 60/855,259. The entire contents of the foregoing provisional application are incorporated herein by reference.

### BACKGROUND

1. Technical Field

The present disclosure relates to the field of membranes and membrane systems. More particularly, the present disclosure relates to the production and utilization of membranes and membrane systems using polyolefin (e.g., polypropylene, polyethylene, etc.) as a support material. Membranes and membrane systems described herein may be used in a variety of applications, including, but not limited to, microfiltration (herein also referred to as “MF”), ultrafiltration (herein also referred to as “UF”), nanofiltration (herein also referred to as “NF”), low pressure reverse osmosis (herein also referred to as “LPRO”), protein separation, water treatment, organic solvent-based UF or NF, and waste water treatment.

2. Background Art

Many different materials have been used in the production of membranes and membrane systems. Often times, the range of applications for a particular membrane/membrane system is limited by the inherent properties, e.g., chemical resistance or hydrophilicity, of the forming material.

Current materials rarely have all of the properties desired for a given application. Thus, optimizing a membrane/membrane system for a particular application is difficult to achieve. To this end, different methods may be used to alter particular characteristics of a given material in order to meet the requirements of an application. More recently, the use of highly alterable thermoplastic polymers in the production of membranes/membrane systems has gained interest.

Interfacial polymerization (herein also referred to as IP) is a powerful technique for producing composite membranes and membrane systems. Membranes produced using interfacial polymerization generally include a support structure and a selective layer interfacially polymerized over the support structure. The thickness of the interfacially polymerized selective layer is, typically, greater than or equal to 20 nm. Originally, composite membranes were designed for reverse osmosis (herein also referred to as RO). Post-interfacial polymerization treatments have been used to increase the pore size for RO membranes. Many different types of polymers may be interfacially synthesized using interfacial polymerization. Polymers typically used in interfacial polymerization applications include, but are not limited to, polyamides, polyurea, polypyrrolidines, polyesters, polyurethanes and polysiloxanes.

In general, the structure of a selective layer formed using interfacial polymerization may be studied by infrared spectroscopy (herein also referred to as IR), positron annihilation lifetime spectroscopy (herein also referred to as PALS), X-ray photoelectron spectroscopy (herein also referred to as XPS), transmission electron microscopy (herein also referred to as TEM), small angle X-ray scattering (herein also referred to as SAXS), and the like.

Membranes and membrane systems produced through interfacial polymerization techniques may be hydrophobic or hydrophilic in nature. Hydrophilic solvent-stable ultrafiltration (herein also referred to as UF) membranes have many distinct advantages. For example, hydrophilic membranes can easily be used in applications involving aqueous solutions, whereas hydrophobic membranes are generally not effective in such environments due to differences in water bubble point pressure (the water bubble point pressure is a high 2.9*10⁷ Pascals for hydrophobic pores having a diameter of 10 nanometers). Furthermore, a hydrophobic membrane, unlike a hydrophilic membrane, experiences increased fouling due to the plugging of pores with biological macromolecules containing hydrophobic segments.

In some instances, hydrophobic polymers, such as polypropylene, high density polyethylene, and low density polyethylene have been treated by plasma, and subsequently contacted with polyethyleneimine solution and epoxy adhesive in order to improve adhesion of a hydrophilic coating material to the polymer.

Most support structures used for interfacial polymerization are currently fabricated from polysulfone or polyethersulfone. These support materials do not have sufficient stability for use in applications involving non-aqueous media in pressure-driven membrane processes. These support materials also exhibit limitations at extreme pH levels. Moreover, emerging applications involving non-aqueous solutions in processes that are not pressure driven may be expected to raise membrane-related issues.

With particular reference to nanofiltration, such applications have gained attention at least in part based on the relatively low operating pressures, high fluxes and low operation and maintenance costs associated therewith. Nanofiltration is well established for aqueous systems, but is still under development for non-aqueous systems mainly due to the lack of solvent resistant nanofiltration membranes. Commercially available nanofiltration membranes claiming solvent resistance have been explored for a number of applications and their solvent stability studied. It has been reported that membranes claiming to be solvent resistant failed in a long run [Bruggen, B. V.; Geens, J.; Vandecasteele, C., “Influence of organic solvents on the performance of polymeric nanofiltration membranes,” Sep. Purif Tech. 2002, 37, (4), 783-797].

Nanofiltration membranes are generally fabricated by making composite membranes. Thin film composite membranes may be fabricated via interfacial polymerization to provide high fluxes as compared to other nanofiltration membranes [Lu, X.; Bian, X.; Shi, L., “Preparation and characterization of NF composite membrane.” J. Member. Sci. 2002, 210, 3-11]. In such fabrication techniques, reactive monomers are dissolved in two immiscible phases and the polymerization of the reactive monomers takes place on the surface of the porous support membrane, thereby permitting control of membrane properties by optimizing the characteristics of the selective layer and support. The selective layer can be optimized for solute rejection and solvent flux by controlling the coating conditions and characteristics of the reactive monomers. The microporous support can be selectively chosen for porosity, strength and solvent resistance. The support membranes generally used are polysulfone or polyethersulfone ultrafiltration membranes. These supports have limited stability for organic solvents and, therefore, the thin film composites fabricated with such supports can not be effectively utilized for solvent resistant nanofiltration applications.

Given the current obstacles, limitations and problems associated with the production and use of membranes and membrane systems, new and improved membranes and membrane systems are needed. More specifically, current and emerging applications, e.g., applications using non-aqueous media in pressure-driven membrane processes, present a need for production of membranes that exhibit greater stability.

The membrane products and membrane-related methods of the present disclosure advantageously address and/or overcome the obstacles, limitations and problems associated with current membrane technologies and effectively address membrane-related needs that are noted herein.

### SUMMARY

Advantageous membranes and membrane systems and methods for the production of such membranes and membrane systems are provided according to the present disclosure.

Membranes for use in filtration methods may be formed from various thermoplastic polymers. Properties of thermoplastic polymers may vary and different combinations of these properties may be beneficial for particular applications. Polyolefins including, but not limited to polypropylene, polyethylene and poly(4-methyl-1-pentene) exhibit particularly beneficial properties. For example, polypropylene (herein also referred to as PP) is pH stable, chemically stable, and solvent stable. Polyolefins are, however, generally hydrophopic.

In fabricating desirable membranes and membrane systems, however, the ability to render an otherwise hydrophobic polyolefin membrane hydrophilic would be beneficial for many applications. Toward that end, in exemplary embodiments of the present disclosure, methods for hydrophilizing a polyolefin membrane are presented. Parameters associated with membranes resulting from the hydrophilizing methods disclosed herein (e.g., pore size) are also optimized for desired separation methods and/or implementations. In general, pore sizes may be controlled in order to produce membranes suitable for microfiltration (MF), ultrafiltration (UF), nanofiltration (NF), and low pressure reverse osmosis (LPRO).

In exemplary embodiments, the surfaces around the pores and the outer surfaces of the polyolefin membranes are hydrophilized by controlled chemical oxidation. Following hydrophilization, the surfaces are coated with a hydrophilic layer that may be advantageously synthesized through interfacial polymerization of one or more monomers of the same or different chemical formulation.

The disclosed interfacial polymerization technique is based on a polymerization reaction which takes place at the interface between two immiscible phases, for example, an aqueous phase and an immiscible organic phase (e.g., a hexane phase). Each such phase may include a dissolved monomer. Properties of the resulting membrane may be determined by various parameters associated with such polymerization, e.g., the nature of the solvents and/or monomers, the monomer concentrations and/or reaction times.

Hydrophilic membranes fabricated according to the present disclosure have distinct advantages over hydrophobic membranes. For example and as noted above, hydrophilic membranes can easily be used in applications involving aqueous solutions, whereas hydrophobic membranes cannot due to differences in water bubble point pressure. Furthermore, a hydrophobic membrane, unlike a hydrophilic membrane, experiences increased fouling due to the plugging of pores with biological macromolecules containing hydrophobic segments.

In exemplary embodiments, interfacial polymerization techniques are improved by incorporating appropriate functional groups, thereby allowing for and/or facilitating the formation of a material with tailored hydrophobic/hydrophilic properties and functionalities. Thus, the formation of a high quality membrane having a thin selective layer and possessing solvent resistance is possible using the hydrophilization techniques of the present disclosure. In exemplary embodiments, various factors relating to the support structures, monomers, and hydrophilization/polymerization conditions may influence the ability to reliably produce defect-free membranes.

Polypropylene is an attractive hydrophobic support material for forming a thin film composite membrane due to high durability and resistance to chemicals, pH variations and a substantially wide range of solvents. Utilizing polypropylene as a support structure has historically posed problems due to the uncontrollable modification of polypropylene during the polymerization process. Such modifications are potential sources for defects and translate to non-reproducibility in the results of interfacial polymerization modification.

In exemplary embodiments, a polyolefin (e.g., polypropylene) may be hydrophilized prior to interfacial polymerization. Preparing the surface in this manner may increase wettability with an aqueous solution. Furthermore, hydrophilization may increase adhesion between the coating and the support in an already formed composite membrane. In general, hydrophilization may occur at any time, including before, during or after polymerization.

The disclosed membranes have widespread utility and application. For example, potential applications for solvent-resistant nanofiltration membranes fabricated according to the present disclosure include materials recovery from fermentation broth or whey, dyeing industry applications, separation of active pharmaceutical compounds (e.g., antibiotics), residual reactants and/or solvents in pharmaceutical synthesis, separation of homogeneous catalysts from organic solutions, separation of mineral oil from organic solvents, separation of free fatty acids from vegetable oil, and separation of light hydrocarbon solvents from lube filtrates.

Additional features, functions and benefits of the disclosed products and methods will be apparent from the description of exemplary embodiments which follows, particularly when read in conjunction with the accompanying figures.

### BRIEF DESCRIPTION OF THE DRAWINGS

To assist those of ordinary skill in the relevant art in making and using the subject matter hereof, reference is made to the appended drawings, wherein:

FIG. 1 depicts ethanol flux vs. pressure difference for flat polypropylene membranes post interfacial polymerization. The insert in the top corner includes (i) bare flat polypropylene film and (ii) an exemplary sample (Sample No. 8-3).

FIG. 2 depicts the surface of a flat non-modified polypropylene film.

FIG. 3 depicts the surface of a flat polypropylene film hydrophilized by chromic acid treatment.

FIG. 4 depicts a cross-sectional view of a flat polypropylene film post interfacial polymerization.

FIG. 5 depicts the surface of a flat polypropylene film post interfacial polymerization.

FIG. 6 depicts the surface of a flat polypropylene film post interfacial polymerization.

FIG. 7a depicts the surface of a coated X-10 hollow fiber. The fiber was coated by wetting the hydrophilized surface with an organic solution followed by an aqueous solution.

FIG. 7b depicts defects in the coated surface of an X-10 hollow fiber, wherein the fiber was heat treated with hot water after interfacial polymerization.

FIG. 8 depicts a surface of the third coated layer on an X-10 hollow fiber support.

FIG. 9 depicts a defect in the coated surface of all X-20 hollow fiber.

FIG. 10 depicts the solvent stability for coated PP X-20 hollow fiber membranes (solvent flux and zein rejection vs. time).

FIG. 11 depicts the surface of a coated X-20 hollow fiber.

FIG. 12 is a plot showing the effect of applied pressure on permeate flux of a pure solvent according to an experimental study of the present disclosure.

FIG. 13 is a plot showing the effect of applied pressure on permeate flux of water according to an experimental study of the present disclosure.

FIG. 14 is a plot showing the effect of applied pressure on solute rejection according to an experimental study of the present disclosure.

FIG. 15 is a plot directed to solvent stability of a hollow fiber membrane according to an experimental study of the present disclosure.

### DESCRIPTION OF EXEMPLARY EMBODIMENT(S)

Thermoplastic materials including, but not limited to, polyolefins—and particularly polypropylene—may be utilized as support structures for producing composite membranes and membrane systems according to the present disclosure. In exemplary embodiments, a single polyolefin, e.g., polypropylene, polyethylene or poly(4-methyl-1-pentene) may be used in fabricating an advantageous support structure. For example, polypropylene, polyethylene or poly(4-methyl-1-pentene) may be used to form the support structure for a given membrane/membrane system. Membranes produced using polyolefin support structures as described herein have many advantageous properties including, but not limited to, hydrophilicity, solvent stability and/or desirable pore size range(s). In general, the characteristics of the disclosed support structure, e.g., composition, form, density, etc., may be controlled in order to vary one or more properties of the resulting membrane or membrane system. Thus, membranes and membrane systems produced according to the present disclosure may be used in a range of applications including, but not limited to, ultrafiltration, nanofiltration, and/or low pressure reverse osmosis.

In exemplary embodiments, methods for modifying a polyolefin, e.g., polypropylene, for use in a membrane system may include treating the polyolefin/polypropylene prior to interfacial polymerization. For example, the polyolefin/polypropylene may be hydrophilized prior to interfacial polymerization. Treatment parameters for particular polyolefin/polypropylene structures may differ, in exemplary embodiments, due to differences in design, structure and/or application, e.g., geometry, membrane handling and/or fluid flow. Polyolefin/polypropylene structures may include, but are not limited to, films, fibers and/or combinations thereof. In exemplary embodiments of the present disclosure, polyolefin/polypropylene structures may include solid and/or hollow sections.

Leak-proof modules may be utilized to facilitate treatment of structures of differing geometries. For example, a leak-proof module may be fabricated using microporous polyolefin/polypropylene hollow fibers potted in a module. Exemplary hydrophilization and interfacial polymerization processes in hollow fiber modules may include the use of a pump connected to the hollow fiber module. Solutions may pass through the lumen side of the fibers. In exemplary embodiments, a valve may be positioned downstream of the hollow fiber module to control the pressure. Multiple flow lines may be used to pass different solutions, thereby reducing the need to wash, flush or otherwise clean the lines during the treatment processes.

Hydrophilization may be accomplished using many different means/techniques. One possible approach/technique involves use of an oxidation process, e.g., chemical oxidation, ultraviolet radiation oxidation, or plasma oxidation. Hydrophilization may also be accomplished using any appropriate surface-modifying technique including, but not limited to, ion implantation, controlled ozonation, or covalent binding of hydrophilic moieties to the hydrophobic surface through grafting.

In exemplary embodiments, a polyolefin/polypropylene support structure may be treated with a wetting fluid prior to oxidation. Wetting fluids may include, but are not limited to, organic liquids miscible with water, such as a ketone (e.g., acetone). Sections of the polyolefin/polypropylene structure may be immersed in an organic liquid (e.g., acetone) for a period of time needed to wet the membrane. Immersion times may vary.

Chemical oxidation techniques for hydrophilization may include use of an oxidizing agent. Exemplary oxidizing agents include, but are not limited to, chromic acid, potassium permanganate, potassium persulfate solutions, ozone, hydrogen peroxide (H₂O₂) and combinations thereof. Differing geometries of a polyolefin/polypropylene structure may affect treatment modalities. Thus, treatment methods for polyolefin/polypropylene structures, such as films and fibers, may differ.

In exemplary embodiments, a chromic acid solution for hydrophilization of polyolefin/polypropylene films may include a mixture K₂Cr₂O₇ with H₂O and H₂SO₄ having a weight ratio of about 1:19:29.4. Weight ratios of the constituents of the chromic acid solution may, however, vary. Further, exemplary embodiments may include, but are not limited to mixtures such as Na₂Cr₂O₇ with H₂O and H₂SO₄.

In an alternative approach/technique, a polyolefin/polypropylene section may be dipped into a chamber/pan containing a chromic acid solution. Generally, conditions in the chamber/pan may be controlled in order to optimize the resultant membrane. Conditions and/or parameters that are typically controlled include, but are not limited to, temperature, oxidant solution concentration, density of the solution, viscosity of the solution and/or pressure gradient across the membrane being oxidized. For example, to prevent solvent evaporation, the chamber/pan may be covered and placed in an oven at about 65° C. for about 30-40 min. The polyolefin/polypropylene structure may be washed to remove residual materials after hydrophilization.

After hydrophilization, polyolefin/polypropylene structures may be stored, e.g., in fluid, until used for production/fabrication of a composite membrane according to the present disclosure. In exemplary embodiments, storage fluids may include, but are not limited to, water, reverse osmosis water, deionized water, a polar protic solvent (e.g., alcohol and/or glycerol) or combinations thereof. For example, the polyolefin/polypropylene support section may be stored in deionized water prior to interfacial polymerization.

In exemplary embodiments of the present disclosure, modification of the inner surface of hollow fibers may include wetting the pores, e.g., with a ketone (e.g., acetone). After the wetting process, excess solvent/acetone on the lumen side of the fibers may be removed by passing air though the fibers at a low flow rate.

In addition, exemplary embodiments may include continuous circulation of the chromic acid solution through a bore in the fibers. In some embodiments, the temperature and/or pressure of the chromic acid may be controlled. For example, the temperature of the chromic acid may be controlled within a range from about 60° C. to about 70° C. and pressure may be controlled at about 5 psig (34.5 kPa). Operating conditions may be controlled to allow and/or optimize the degree to which the chromic acid solution replaces the wetting fluid, e.g., acetone, in the pores. After treating the inner surface of fibers for a predetermined time period, the “used” chromic acid solution may be replaced with fresh chromic acid solution; the replacement chromic acid solution may be at the same or a different concentration as the “used” chromic acid solution.

The disclosed membranes may be washed with water passed through the fiber lumens to remove chromic acid from the lumen side of the module, the shell side of the module, and/or the pores of the fibers. Conditions relating to the circulating water may be controlled. For example, the circulating water may be introduced at a pressure of about 10 psig (69 kPa) and may be circulated for about 30 minutes.

The particular geometry of the disclosed polyolefin/polypropylene structure may affect the coating achieved using interfacial polymerization. The geometry of the disclosed polyolefin/polypropylene structure may also affect the characteristics of the resultant membrane, e.g., relating to the flow of solution through the system. For example, fiber coating techniques and/or conditions for interfacial polymerization may differ from coating techniques and/or conditions on flat films because of differences in geometry, handling of the membranes and/or solution flow.

Various fibers may be used in the membranes and membrane systems of the present disclosure. Thus, the disclosed membranes/membrane systems may utilize hollow and/or solid fibers. The inner diameter of hollow fibers incorporated into the disclosed membranes and membrane systems may be relatively small, e.g., ranging from about 10 μm to about 800 μm. The length of individual fibers may vary from implementation-to-implementation, and such length may affect interfacial polymerization of the fibers.

Individual fibers may be coated on an outer surface thereof. An outer surface coating may be uneven, in some cases. For example, the coating may be minimized or non-existent in areas where two or more fibers are in close contact with one another. Measures may be taken to inhibit the disclosed polyolefin/polypropylene structures, such as fibers, from contacting each other, thereby ensuring and/or promoting more uniform coating thereof. Thus, in exemplary embodiments, leak-proof hollow fiber membrane modules may be fabricated to house and disperse the disclosed polyolefin/polypropylene hollow fibers. For example, polyolefin hollow fibers, e.g., microporous polyolefin, may be potted in a module that defines a desirable geometry.

Coating by interfacial polymerization may also occur on the inside surface of the disclosed hollow fibers. For coating on the inner surface, the monomer-containing solution may be passed through the lumen side of the fibers. Various parameters, e.g., the flow behavior of the monomers during the coating process in hollow fibers, can influence the characteristics of the polymerized coating. For example, the removal of excess monomers from the lumen side of the fibers may affect monomer polymerization on the surface of the support. Thus, in exemplary embodiments, coating characteristics may be affected by the flow behavior and monomer removal. Heat treatment of the coating may also be used to: (i) complete the polymerization process, (ii) remove the organic solvent, and/or (iii) render unreacted monomers insoluble.

In exemplary embodiments of the present disclosure, a polypropylene membrane, previously oxidized by a chromic acid solution, may be soaked in an aqueous solution of poly(ethyleneimine) (PEI). For example, a flat polypropylene membrane may be soaked in an aqueous solution of poly(ethyleneimine) having a concentration in a range from about 0.5 to about 2.0 weight % for about 15 minutes. The treated membrane may be drained, placed and secured on a polytetrafluoroethylene (PTFE) support, e.g., a cylindrical polytetrafluoroethylene roller support.

Exemplary embodiments may include reacting the membrane with a xylene solution of iso-phthaloyl dichloride having a concentration in a range from about 0.1 to about 1 weight %. A typical interfacial polymerization reaction time may be in a range from about 30 seconds to about 5 minutes.

In general and as noted above, any method of interfacial polymerization may be utilized according to the present disclosure. For example, an organic reactant solution may be delivered to a flat-spread hydrophilized polyolefin/polypropylene membrane. The flat-spread hydrophilized polyolefin/polypropylene membrane may have been previously treated with a diamine and/or polyamine monomer solution. After interfacial polymerization, the disclosed membranes may be treated with and/or subjected to heat. For example, membranes may be heated to 110° C. for about 20 minutes. In other exemplary embodiments, membranes may be detached from the PTFE roller support and kept under ambient air conditions.

Exemplary membranes and membrane systems of the present disclosure may involve production of leak-proof hollow fiber membrane modules fabricated using microporous polyolefin/polypropylene hollow fibers potted with a general purpose epoxy. Coating by interfacial polymerization on the inner surface of the hollow fibers may utilize monomers 1,6-hexanediamine and sebacoyl chloride. In exemplary embodiments, poly(ethyleneimine) and iso-phthaloyl dichloride may be used in combination with 1,6-hexanediamine and sebacoyl chloride on fibers having an inner diameter larger than about 25 μm.

Modification of the hydrophilized inner surface of the disclosed polypropylene fibers may occur in a hollow fiber module by passing an aqueous solution including 1,6-hexanediamine through the lumen side thereof. For example, an aqueous solution of 1,6-hexanediamine at a concentration in the range of about 1 to about 2 weight % may be passed through the lumen side at a pressure of about 5 psig (34.5 kPa) for 15 min. Exemplary embodiments may include purging the hollow fiber module to remove the excess aqueous solution from the lumen side. For example, a flow of air at a flow rate of about 3 cm³/s may be maintained for a predetermined period of time. A pressurized aqueous diamine solution may also be introduced on the lumen side of the fibers. In this manner, the diamine solution may replace the water present in the pores of the polypropylene support.

In further exemplary embodiments of the present disclosure, sebacoyl chloride in a xylene solution at a concentration in the range of about 1 to about 2 weight % may be introduced from the tube side at a very low flow rate for a time period equal to the reaction time (e.g., about 1.5 minutes to about 2.5 minutes). During interfacial polymerization, the membrane module may be positioned vertically. After removal of the excess organic solution, the coating may be treated using heat. Heat treatment techniques may include, but are not limited to, passing hot water at 65° C. for 30 minutes, passing hot air at 65° C. for 30 minutes, and placing the module in an oven at 110° C. for 20 minutes. In exemplary embodiments, the modules may be dried by passing air through the fibers at a controlled temperature. In addition, modules may be washed with ethanol to remove unreacted monomers prior to characterization.

Interfacial polymerization according to the present disclosure may be undertaken with reactions that proceed in varying orders. For example, after hydrophilization, a membrane may be wetted with an organic monomer solution followed by flowing aqueous monomer solution through the fiber bore. The organic monomer solutions may include, but are not limited to, a xylene solution of iso-phthaloyl dichloride having a concentration in a range from about 0.1 to about 1 weight %, sebacoyl chloride in a xylene solution having a concentration in the range of about 1 to about 2 weight %, an alternative organic monomer solution, and/or combinations thereof. In exemplary embodiments, aqueous monomer solutions may include, but are not limited to, an aqueous solution containing 1,6-hexanediamine at a concentration in the range of about 1 to about 2 weight %, poly(ethyleneimine) having a concentration in a range from about 0.5 to about 2.0 weight %, an alternative aqueous monomer solution, and/or combinations thereof. Concentrations of solutions used in interfacial polymerization may be in a range from about 0.01 weight % to about 30 weight %. Preferably, concentrations of the interfacial polymerization solutions may be in a range from about 0.5 weight % to about 2 weight %.

The disclosed interfacial polymerization reaction time may vary. For example, an interfacial polymerization reaction time may be in a range from about 10 seconds to about 2 hours. In exemplary embodiments, the reaction time may be in a range from about 30 seconds to about 15 minutes. Alternately, the reaction time may be in a range from about 30 seconds to about 5 minutes.

The disclosed module/fiber coatings may be dried in connection with the disclosed fabrication techniques. For example, the module may be exposed to ambient air to dry the coating.

The disclosed hollow fibers may be modified using an amine reactant solution and a diacyl chloride reactant solution. For example, hollow fiber modification may include using 0.5 weight % aqueous poly(ethyleneimine) solution and 0.5 weight % iso-phthaloyl dichloride solution in xylene. Hollow fiber modification of fibers with larger inner diameters may include allowing the solution to be retained, i.e., stand still inside the lumen of the fibers, during the interfacial polymerization process.

Organic solution may be passed through the fibers with the module in a vertical orientation in exemplary embodiments of the present disclosure. Flow of the organic solution through the fibers may be stopped/discontinued as the organic solution reaches the other end of module. After a period of up to about 10 minutes, the organic solvent may be removed from the bore side of the hollow fibers. Organic solution removal may be achieved, at least in part, by introducing air flow through the module. A heat treatment may also be used to treat the fiber coating. For example, a fiber coating may be treated with heat by placing the module in an oven at 110° C. for 20 minutes.

Other embodiments of membrane formation/fabrication according to the present disclosure may involve varying the concentrations of the monomer solution(s). In exemplary embodiments, higher monomer concentrations may result in or yield membranes suitable for nanofiltration. For example, monomer concentrations may be utilized that are in a range from about 0.5 weight % to about 0.85 weight %. In one embodiment, an aqueous solution of 0.75 weight % poly(ethyleneimine) and 0.75 weight % iso-phthaloyl dichloride in xylene is utilized and yields a membrane suitable for nanofiltration. Of note, in exemplary embodiments of the present disclosure, membranes may be characterized by measuring solute rejection and/or solvent flux.

Another example of an interfacial polymerization technique for application to a polyolefin/polypropylene membrane according to the present disclosure is described below. In particular, flat polypropylene membranes may be subjected to a “modified interfacial polymerization” procedure wherein different solutions may pass through the pores of the flat membranes during the modification process. An apparatus that includes a glass porous support and a reservoir may be used to support the membrane. The membrane may be clamped between the porous support and the reservoir. Vacuum may be pulled through the porous support to pull the solutions (e.g., monomer solutions/water/chromic acid solutions) through the membrane.

Polypropylene flat membranes may be hydrophilized according to the present disclosure by treating with hot chromic acid solution. Concentration and treatment times may be the same as that disclosed herein for flat membranes hydrophilized for interfacial polymerization. To facilitate hydrophilization of the entire pore interior of polypropylene flat films, the membranes may be pre-wetted with acetone and chromic acid solution may be forced through the membranes using the technique disclosed above.

Membranes hydrophilized by the disclosed chromic acid treatment may be washed with water, e.g., for 20 minutes. Then, pores of the membrane may be filled with an amine monomer dissolved in water (e.g., in a range from about 0.5 weight % to 6 weight % of PEI). The membranes may be dried by pulling vacuum, e.g., for 5 hours. Then, the membranes may soak in the organic monomer containing solution, e.g., at a concentration of about 0.5 to 2 wt. %, for a period of time, e.g., ten minutes, to coat the pore interior and the surface of the membrane with the hydrophilic polyamide reaction product. After polymerization, the modified membranes may be heat treated, e.g., in an oven at 110° C. for 20 minutes.

The modified membranes disclosed herein may be characterized by measuring the breakthrough pressures for water and the water permeation rates using a flat membrane cell having a set membrane area. Water permeation and breakthrough pressures may be measured without pre-wetting or when employing a pre-wetting agent (e.g., ethanol or acetone). For breakthrough pressure measurements, the applied pressure may be increased in steps of about 5 psi (34.5 kPa). The membrane cell may be as described with reference to flat membrane studies herein.

As the concentration of PEI (i.e., weight percentage) for the modification increases, the breakthrough pressures for water may decrease. At high PEI concentrations (i.e., about 6 weight %), PEI may have covered the surface of the flat film, as well as the pore interior, after the removal of water. As a result, the breakthrough pressure may increase.

Characterization of the coated flat films and hollow fiber membranes may be undertaken using a scanning electron microscope (SEM). In exemplary embodiments, hollow fibers may be taken out of the module and the cross section of the fiber sliced at an angle to obtain SEM pictures of the coating on the inner surface thereof.

Characterization of the coated fibers and films may include comparisons to bare polypropylene members. For flat bare polypropylene membranes, Image Pro Plus software from Media Cybernetics, Inc. (Bethesda, Md.) may be used to estimate average pore size and surface porosity. In exemplary embodiments, an average effective pore radius may be equivalent to the ratio of the doubled pore area to the pore perimeter.

Characterization of flat polypropylene membranes of modified and non-modified samples of flat films may include measurements of nitrogen permeance or ethanol permeability. In exemplary embodiments, a constant pressure setup may be used with a standard permeation cell using a pure gas (or liquid) source at a constant pressure connected upstream, and the permeate side open to the atmosphere. The volumetric flow rate of the permeate gas through a membrane area (Aₘ) may be measured by a soap bubble flow meter. An applied pressure difference (ΔP) may be controlled in a range from about 6 psi to about 60 psi (41-414 kPa). For example, ethanol permeability characterization may be carried out at a ΔP=15-60 psi (103-414 kPa).

Hollow fiber membranes may be characterized by measuring a reduction in solvent flux (70 v % ethanol in water) and zein rejections. Zein is a corn protein having a molecular weight of 35,000. Belonging to the group prolamins, zein is a globular protein insoluble in both pure water and alcohol, but soluble in 70-80% alcohol solutions. Permeability of water through the coated hollow fibers may also be measured to study the hydrophilicity of the coated membranes.

After fabrication of the disclosed membranes, the coated membranes may be tested for solvent stability using the following procedure. Coated membrane modules may be soaked in a solution of about 70% ethanol in water at room temperature for a period of time and periodically tested for zein rejection and solvent flux.

Of note, coating using interfacial polymerization generally differs for fibers as compared to films. The primary differences in geometry, handling of the membranes, and solution flow may affect the process used. Exemplary implementations of the present disclosure include coating a film, such as a flat membrane. Flat membranes may be dipped in the monomer-containing solution.

Exemplary embodiments of the interfacial polymerization technique are based on a polymerization reaction taking place at the interface between two immiscible phases, for example, an aqueous phase and an immiscible organic phase (e.g., a hexane phase). Each phase may include a solution including a dissolved monomer. Concentrations of the dissolved monomer may vary. Exemplary embodiments may include using one or a combination of monomers in each phase. Variables in the system may include, but are not limited to, the nature of the solvents, the nature of the monomers, monomer concentrations, and reaction time. Such variables may be controlled to define the properties of the membrane, e.g., membrane porosity, pore size, and thickness of a selective layer. In exemplary embodiments, monomers used in the solution may include, but are not limited to, diamine and diacyl chloride. The resulting reaction product may include polyamide forming a selective layer on the membrane.

Of note, the disclosed interfacial polymerization technique may include incorporating appropriate/desirable functional groups into the membrane and/or membrane system. Inclusion of such functional groups may advantageously facilitate formation of a membrane/membrane system with tailored hydrophobic/hydrophilic properties and functionalities. For example functional groups may be employed/introduced during membrane formation using interfacial polymerization to increase one or more qualities/attributes of the membrane, e.g., solvent resistance of the membrane and/or hydrophilicity of the membrane.

For example, increasing the fraction of methylene groups in the main chain of aliphatic polyamides leads to a dramatic increase of water contact angle. In this case, for nylon 4,6, the advancing contact angle was measured to be 58°, but for nylon 12 the advancing contact angle increased by about 20 degrees. Thus, hydrophobicity of the membrane may be increased when appropriate monomers having suitable functionalities are used/incorporated. For example, isotactic polypropylene is a hydrophobic polymer having a contact angle with water of 116 degrees; thus, increasing the fraction of methylene groups in the main polypropylene chain may increase the water contact angle.

It is further noted that individual fibers may be coated on an outer surface thereof according to the present disclosure. Prior to coating, fibers may be positioned to ensure that the fibers are separated from each other. For example, a module for housing the fiber may be fabricated. In exemplary embodiments, the module may be leak-proof. Microporous polypropylene fibers may be potted in the module. In exemplary embodiments, the microporous polypropylene fibers may be hollow. Exemplary embodiments may include coating inner surfaces of the hollow fibers using interfacial polymerization. When coating the inner surface of the hollow fibers, the monomer-containing solution typically passes through the lumen side of the fibers.

Flow behavior of the monomers during the coating process in hollow fibers may influence the characteristics of the thin film. In exemplary embodiments, an inner diameter of the polypropylene fibers is small (e.g., in a range from about 100 μm to about 800 μm). Excess monomer may be removed uniformly from the lumen side of the fibers in the membrane module without complete or partial elimination of the monomer solution coated on the support. Exemplary embodiments may include heat treatment of the coating to complete the polymerization process, remove the organic solvent, and/or insolubilize unreacted monomers. Heat treatment techniques generally include any method capable of raising the temperature inside the module, such as by passing hot water proximate the module at a given temperature for a predetermined time (e.g., at 65° C. for 30 minutes), passing hot air at a given temperature for a predetermined time (e.g., 65° C. for 30 minutes) and/or placing the module in an oven at 110° C. for 20 minutes. In exemplary embodiments, heat treatment temperatures may be in a range from about 50° C. to 200° C. An optimal temperature for heat treatment typically depends on the treatment technique-at-issue. Treatment times typically vary from about 0.5 minutes to about 5 hours.

Removal of the organic solvent may improve adhesion between the support and a selective layer. For example, decreasing actual inter-atomic distances may increase adhesion, at least in part because such adhesion is based on weak attraction forces. Heat treatment may also influence the final morphology of the coating and related coating characteristics. Factors which may be controlled to influence a coating on the polyolefin/polypropylene fibers include, but are not limited to, hydrophilization of the fibers, concentration of the monomers, reaction times, removal of excess monomer from the lumen side and/or heat treatment techniques. One or more factors associated with the disclosed interfacial polymerization process may be varied to provide a coating on an inner and/or outer surface of the hydrophobic hollow fibers, as described herein.

In exemplary embodiments, polyolefins used in fabricating the disclosed structures may include, but are not limited to, polypropylene in its various forms, including isotactic polypropylene, syndiotactic polypropylene, atactic polypropylene, and/or a combination of one or more such forms. Exemplary implementations of the present disclosure employ isotactic polypropylene which is semi-crystalline in structure.

The kinetics of oxidation of the crystalline and amorphous regions of the disclosed polyolefin/polypropylene may differ. For example, amorphous regions of polypropylene may have a tendency to bury oxidized groups inside while drying or changing the media to hydrophobic. In some instances, polypropylene may not be wettable by strong aqueous-based oxidants (e.g., chromic acid, potassium persulfate, etc.). Use of strong aqueous-based oxidants may increase non-uniformity of the membrane surface modification, resulting in poor quality of the selective layer of a thin film composite membrane. Exemplary embodiments are generally adapted to provide enhanced contact between oxidant and the treated surface to potentially improve the uniformity of the modification.

Properties of polypropylene supports, such as membrane thickness, average pore size, shape, porosity, pore tortuosity, polymer stereochemistry, may vary according to the present disclosure. In exemplary embodiments, membrane average effective pore radius may be in a range from about 3 nm to about 800 nm. Exemplary embodiments may include membranes having an effective pore radius in a range from about 10 nm to about 40 nm. For example, microporous polypropylene membranes according to the present disclosure may have an average pore size of about 42 μm by about 117 nm (short and long axis, respectively). In exemplary embodiments, the average pore radius corresponding to the short axis is about 30 nm and the average pore radius corresponding to the long axis is about 37 nm. Other properties of the microporous polypropylene membrane may include a thickness of about 25 μm and a volume porosity of about 37%. The pore tortuosity may be in a range from about 1 to about 5, e.g., about 2.7. Gas flux through a flat membrane of polypropylene may obey Knudsen law with a very slight contribution of Poiseuille flow at low pressure differences of about 80 kPa or less and absolute pressure values of about 1 atmosphere. An interfacially polymerized coating may be characterized by gas permeation, as well as, by liquid permeation.

As noted above, polypropylene flat films and polypropylene hollow fibers may be modified by chemical surface oxidation. Surfaces to be modified may include both inner and outer surfaces of such polypropylene structures. For example, an inner surface of a polypropylene hollow fiber may be modified by chemical surface oxidation. Conventional techniques, such as UV activation and plasma-based approaches may have reduced efficacy, especially when modifying the inside surfaces of hollow fibers.

Surface modified hydrophilic polyamide films and fibers formed by interfacial polymerization may be characterized in a number of ways. Exemplary embodiments may create pore sizes smaller than the original substrate, but larger than reverse osmosis membranes. Resulting membranes may be classified by various methods, e.g., pure gas permeation, pure liquid permeation, macrosolute transport and/or other characterization methods. For example, membranes may be evaluated for use in ultrafiltration using ethanolic solutions (e.g., an ethanolic solution of the corn protein zein).

An example of the characterization methods described herein includes the use of the following materials: N₂ (high purity); Celgard 2400 flat polypropylene membrane (25 μm thick, porosity 37%, pore size 0.117 μm×0.042 μm); Celgard X-10 and X-20 hollow fibers; sebacoyl chloride (99% purity); 1,6-hexanediamine (98% purity); iso-phthaloyl dichloride (99% purity), potassium dichromate (99% purity, ACS reagent); ethanol absolute (99.5% purity, ACS reagent); sulphuric acid (95.7% purity, ACS reagent); acetone (99% purity, histological grade); poly(ethyleneimine) aqueous solution of 50 weight % (polymer average molecular weight between 50,000-60,000; Acros Organics); water (deionized by Barnstead 5023); and zein protein (Freeman Industries, Tuckahoe, N.Y.). A liquid pump controller model #7553-50 (Masterflex, Barrington, Ill.) and a UV-Vis spectrophotometer (Hitachi U-2000) may be employed.

In an exemplary embodiment, chromic acid solution for hydrophilization of flat polypropylene films was prepared by slow mixing of K₂Cr₂O₇ with H₂O and H₂SO₄ in the proportion of 1:19:29.4 by weight. Flat films were immersed in acetone for 5 minutes and subsequently dipped into a pan containing chromic acid solution. The pan was covered with a glass plate and placed in an oven at 65° C. for 30-40 min. Flat films so modified were kept under water overnight and then modified by interfacial polymerization as described below.

An experimental set-up used for hydrophilization and interfacial polymerization of hollow fiber modules included a pump connected to the hollow fiber module to pass solution(s) through the lumen side and a valve positioned after the hollow fiber module to control pressure. Different flow lines were used to pass different solutions to the module, so that washing of the lines was not required during the coating process. Modification of the inner surface of the hollow fibers was undertaken in a module fabricated with the hollow fibers by first wetting the pores with acetone as described above with reference to flat film treatment. Excess acetone in the lumen side of the fibers was removed by passing air at a low flow rate followed by continuous circulation of the chromic acid solution (which was at 65° C.) through the bore of the fibers. Chromic acid was passed at 5 psig (34.5 kPa), so acetone in the pores was slowly replaced by the chromic acid solution. After carrying out the treatment for 30 min, the “used” chromic acid solution was replaced with a fresh chromic acid solution of the same concentration, and hydrophilization was carried out for another 30 min. The membranes were then washed by introducing water through the lumen side at a pressure of 10 psig (69 kPa) for 30 minutes to remove chromic acid from the lumen and shell side of the module as well as from the pores. The washing procedure was followed by interfacial polymerization.

In particular, an exemplary flat porous polypropylene membrane previously oxidized by chromic acid solution was soaked in an aqueous solution of poly(ethyleneimine) having a concentration varying between 0.5 to 2.0 weight % for about 15 minutes. Subsequently, the treated membrane was drained, placed and secured on a cylindrical PTFE roller support and further reacted with a xylene solution of iso-phthaloyl dichloride having a concentration varying between 0.1 to 1 weight %. The interfacial polymerization reaction time was varied between 30 sec and 5 min. The modified membrane was placed in an oven at 110° C., heat treated for about 20 minutes, detached from the PTFE roller support and kept under ambient air conditions.

Leak-proof hollow fiber membrane modules were fabricated according to the present disclosure using Celgard X-10 and X-20 microporous polypropylene hollow fibers potted with general purpose epoxy C-4. Module specifications are given in Table 1.

TABLE 1
Hollow fiber membrane module characteristics

| Characteristics of modules | X-10 modules | X-20 modules |
|---|---|---|
| Hollow fiber membranes | Narrow fibers^{†} | Wide fibers^{††} |
| Internal diameter, μm | 240 | 400 |
| Wall thickness, μm | 25 | 25 |
| Number of fibers | 30 | 6 |
| Nominal porosity | 0.3 | 0.4 |
| Effective module length, cm | 15 | 12 |
| Effective mass transfer area | 34 | 9.0 |

^{†}X-10 hollow fibers
^{††}X-20 hollow fibers

Coating by interfacial polymerization was carried out on the inner surface of polypropylene X-10 hollow fibers with monomers 1,6-hexanediamine and sebacoyl chloride. Next, interfacial polymerization was carried out with (poly(ethyleneimine) and iso-phthaloyl dichloride monomers on X-20 fibers having an inner diameter larger than that of the X-10 fibers. Modification of the hydrophilized inner surface of the polypropylene fibers was carried out in a hollow fiber module by passing an aqueous solution containing 1,6-hexanediamine at a concentration in the range of 1-2 weight % through the lumen side at a pressure of 5 psig (34.5 kPa) for 15 min; then, the excess aqueous solution was removed from the lumen side by purging it gently with air at a flow rate of 3 cm³/s for 1 minute. By pressurizing the aqueous diamine solution in the lumen side of the fibers, water present in the pores of the polypropylene support was replaced with diamine solution. Next, sebacoyl chloride in xylene solution having a concentration in the range of 12 weight % was introduced from the tube side at a very low flow rate for the time period equal to the reaction time (1.5 to 2.5 min) of interfacial polymerization, while the membrane module was held vertical. After the excess organic solution was removed in the same way as the aqueous solution, the coating was heat treated. Different heat treatment techniques have been employed, e.g., passing hot water at 65° C. for 30 minutes, passing hot air at 65° C. for 30 minutes, and placing the module in an oven at 110° C. for 20 minutes. After the heat treatment, the modules were dried overnight by passing air at ambient temperature through the fibers. Modules were washed with ethanol to wash out the unreacted monomers before they were used for characterization.

Of note, the order of the reactions described herein may be altered, e.g., the order of reactions may be reversed. For example, after hydrophilization, the membrane may be first wetted with the organic monomer solution followed by a flow of the aqueous monomer solution through the fiber bore. Comparable monomer concentrations have been achieved in such reversed sequence. Placing the module in ambient air for about 2 hours may be used to dry the coating.

Polypropylene X-20 hollow fiber modification was carried out with 0.5 weight % aqueous poly(ethyleneimine) solution (amine reactant) and 0.5 weight % iso-phthaloyl dichloride (diacyl chloride reactant) solution in xylene. In general, an exemplary procedure for PP X-20 hollow fiber modification is similar to the interfacial polymerization of PP X-10 described above, but instead of passing the organic monomer solution through the fibers, such monomer solution was kept standing still inside the lumen of the fibers during the interfacial polymerization process. Organic solution was initially passed through the fibers holding the module vertical. When the organic solution appeared at the other end of the module, the flow of the organic solution through the fibers was stopped. After a period of up to 10 minutes (considered as the reaction time), the organic solvent was removed from fibers and the excess was removed by blowing gently with air. Then, the coating was heat treated by placing the module in an oven at 110° C. for 20 minutes.

Coated flat films and hollow fiber membranes were characterized by scanning electron microscopy (SEM Leo 1530). The samples were carbon coated prior to the SEM characterization carried out at accelerating voltage of 2-3 kV. In the case of hollow fibers, fibers were taken out of the module and the cross section of the fiber was sliced at an angle to obtain SEM pictures of the coating on the inner surface.

For flat bare polypropylene membranes, Inage Pro Plus software (Media Cybernetics, Inc.) was used to the estimate average pore size and surface porosity. The average effective pore radius was found as the ratio of the doubled pore area to the pore perimeter.

Flat polypropylene membranes of modified and non-modified samples of flat Celgard 2400 films were characterized by nitrogen permeance or ethanol permeability. A constant pressure set-up was used with a standard permeation cell using a pure gas (or liquid) source at a constant pressure connected upstream, and the permeate side open to the atmosphere. The membrane area (Aₘ) of the cell was 7.0 cm². The volumetric flow rate of the permeate gas was measured by a soap bubble flow meter. The applied pressure difference ΔP was in the range of 6-7 psi (41−48 kPa). Ethanol permeability characterization was carried out at ΔP=15-60 psi (103-414 kPa). The permeate volumetric rate was found as the ratio of the volume of collected permeate to the time interval of the experiment (30-60 min).

Hollow fiber membranes were characterized by measuring reduction in solvent flux (70 v % ethanol in water) and zein rejection. As noted herein, zein is a corn protein having a MW of 35,000, belonging to prolamins (globular proteins which are insoluble in both pure water and alcohol, but soluble in 70-80% alcohol solutions). Both X-10 and X-20 support membranes showed no rejection of zein protein for a 1 g/l feed protein solution. Water permeability through the coated hollow fibers was measured to study the hydrophilicity of the coated membranes.

The coated membranes were tested for solvent stability by the following procedure. Coated membrane modules were soaked in a solution containing 70% ethanol in water at room temperature for a period of 10 weeks and tested once every week for zein rejection and solvent flux at 138 kPa with a feed solution of 1 g/L zein in 70% ethanol.

The permeances of diatomic nitrogen and permeabilities of ethanol through different membranes is set forth in Table 2 along with each sample's preparation history. As shown in Table 2, membrane samples #6-2, 6-4 and 7-2 are less permeable to nitrogen than FT30 membrane (9.3*10⁻⁴ cm³ (STP)/(cm²*s*cmHg)) [H. Finken, Asymmetric membranes for gas separations, in: D. R. Lloyd (Ed.), Materials Science of Synthetic Membranes, American Chemical Society, Washington, D.C., 1985, p. 258.]. The rest of the membranes are more permeable by about two to seven times.

TABLE 2
Conditions and Properties for Modification of Flat PP Films wwith Interfacially
Polymerized Membranes^{†}

| Sample # | $Q ( {N}_{2} ) / δ , \frac{{cm}^{3} ( STP )}{( {cm}^{2} \cdot s \cdot cm Hg )}$ | $Q ( {C}_{2} {H}_{5} OH ) / δ , \frac{{cm}^{3}}{( {cm}^{2} \cdot s \cdot cm Hg )}$ | Reactants' concentrations | Time of interfacial polymerization |
|---|---|---|---|---|
| 6-2 | (5.72 ± 0.05) * 10⁻⁴ | (9.2 ± 0.2) * 10⁻⁷ | 0.5 wt. % IPD | 2 min |
| | | | 2.0 wt. % PEI | |
| 6-4 | (2.63 ± 0.04) * 10⁻⁴ | (1.81 ± 0.03) * 10⁻⁶ | 0.25 wt. % IPD | 3 min |
| | | | 2.0 wt. % PEI | |
| 7-1 | (1.98 ± 0.08) * 10⁻³ | (1.47 ± 0.03) * 10⁻⁶ | 1.0 wt. % IPD | 1 min |
| | | | 1.0 wt. % PEI | |
| 7-2 | (5.28 ± 0.02) * 10⁻⁵ | (1.00 ± 0.02) * 10⁻⁶ | 1.0 wt. % IPD | 5 min |
| | | | 1.0 wt. % PEI | |
| 8-2 | (2.96 ± 0.09) * 10⁻³ | (2.40 ± 0.04) * 10⁻⁶ | 0.1 wt. % IPD | 1 min |
| | | | 0.2 wt. % PEI | |
| 8-3 | (5.7 ± 0.1) * 10⁻³ | (4.5 ± 0.1) * 10⁻⁶ | 0.1 wt. % IPD | 30 sec |
| | | | 0.2 wt. % PEI | |
| Bare PP | (2.50 ± 0.06) * 10⁻² | (2.90 ± 0.03) * 10⁻⁵ | — | — |
| flat | | 9.5 * 10^{-6†††} | | |
| film^{††} | | | | |
| FT30 | 9.3 * 10⁻⁴ [35] | — | — | — |

^{†}For gas ΔP = 6-7 psi (41-48 kPa), for liquid ΔP = 15 psi (103 kPa), IPD—iso-phthaloyl dichloride, PEI—polyeethyleneimine)
^{††}Celgard 2400
^{†††}Iso-propanol permeability

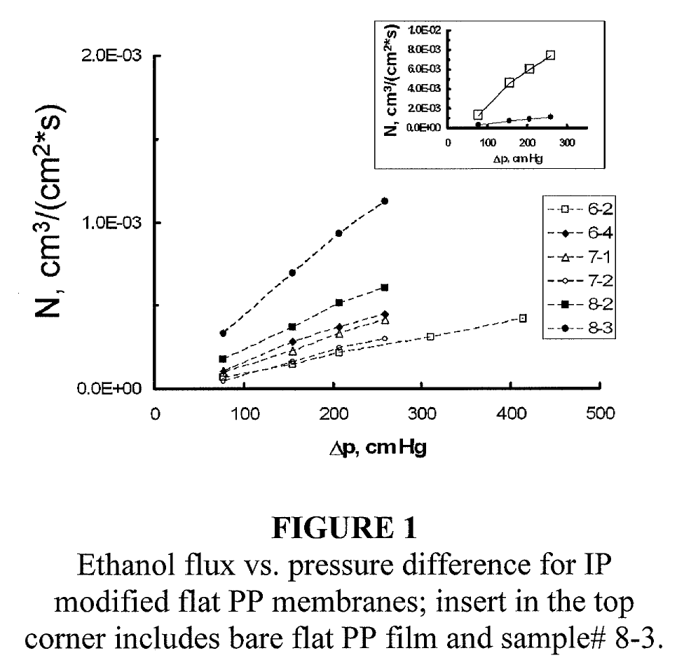

Plots of ethanol flux vs. pressure difference across the modified polypropylene flat membranes are given in FIG. 1. The tendency of the flat modified polypropylene films for pressure dependence was similar to that of the bare polypropylene flat membrane provided in the inset. In particular, there was no permeability increase with increasing ΔP within the studied range. This shows that any pore deformation with an applied pressure increase was minimized. The coated membranes had resilience at such applied pressure forces in this exemplary embodiment. The applied range of ΔP values was standard for ultrafiltration. FIG. 1 also shows that slight compaction occurs at higher pressures.

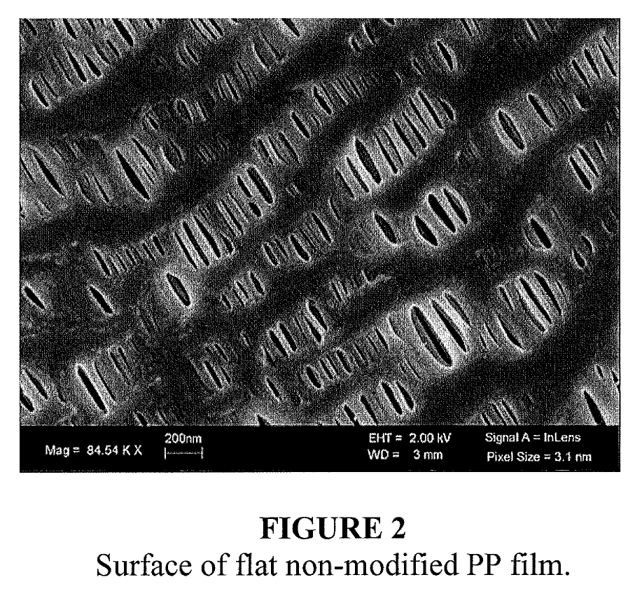

The SEM pictures of the surface and cross section of bare polypropylene flat film and some of the modified samples are provided in FIGS. 2-6. The surface porosity of bare polypropylene flat film (FIG. 2) was found to be about 11% from the SEM picture. This value was lower than the value of 13.7% found from volume porosity and tortuosity which were equal to 37% and 2.7, respectively. The noted differences between the values may be due to differences in the testing regime. For example, the SEM images may have had a reduced contrast, which may have inhibited recognition of small pores. In this embodiment, the first value (1%) is regarded as an underestimate and the second one as an overestimate.

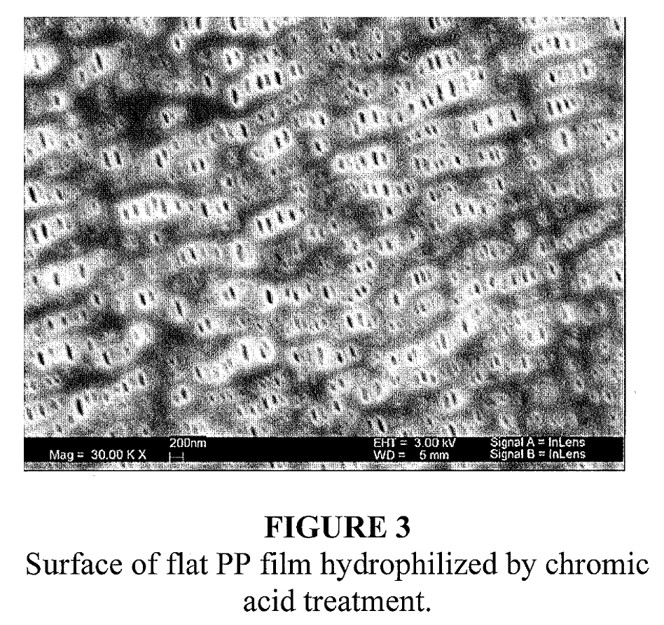

FIG. 3 shows the surface of a polypropylene flat film hydrophilized by the disclosed chromic acid treatment. The image of the oxidized polypropylene membrane was not quite clear because the modified surface charged to a much better extent than the non-modified surface. Of note, the uniformity of the surface oxidative modification may vary.

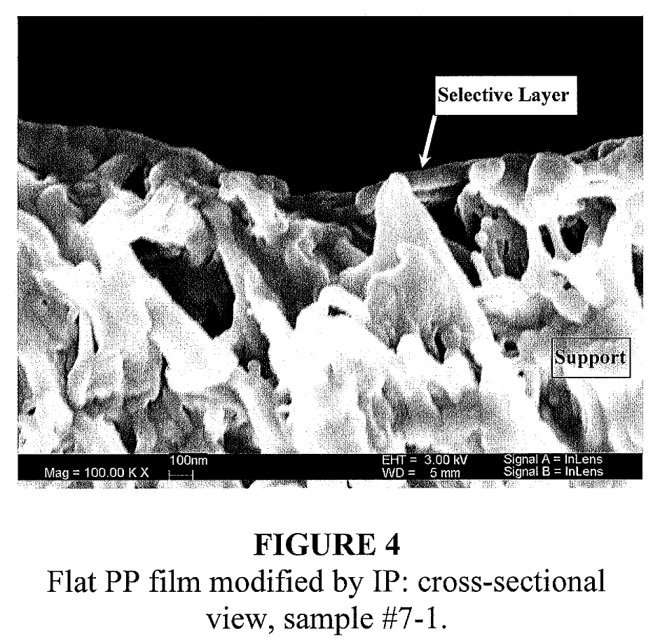

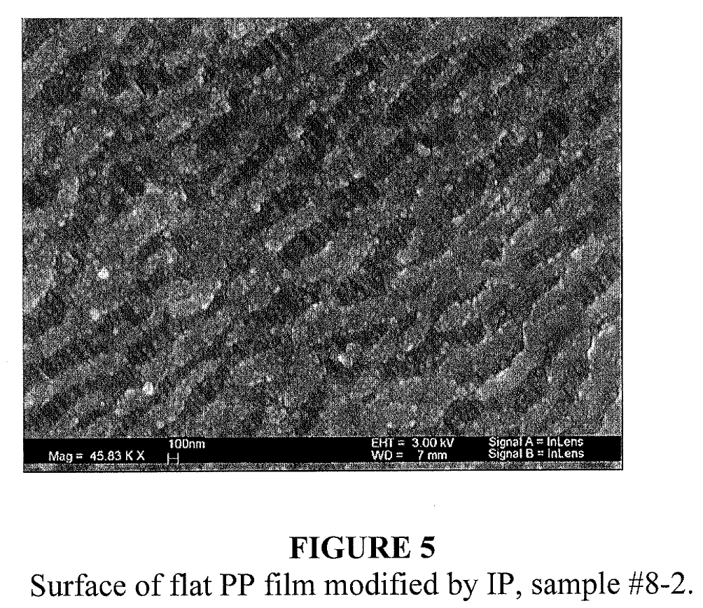

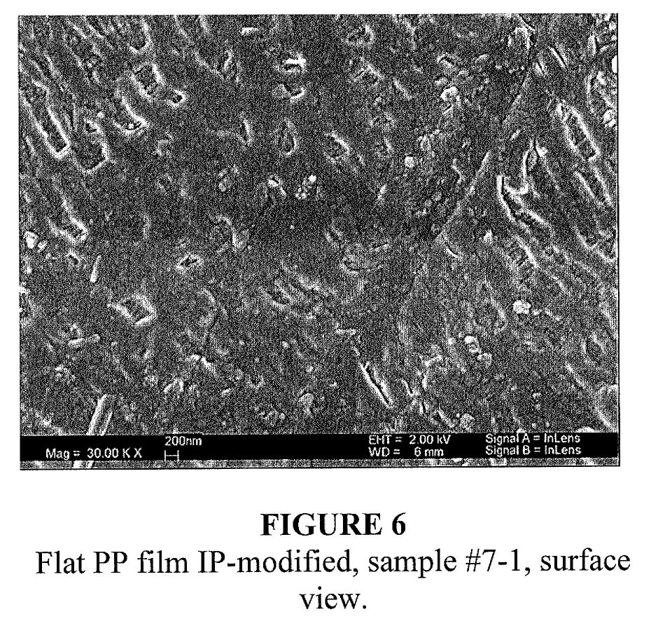

The cross section of a thin film composite membrane (sample # 7-1) shown in FIG. 4 demonstrates the thickness of the interfacially polymerized layer, which was about 100 nm. FIG. 5 and FIG. 6 show a surface view of such interfacially polymerized layers for two membranes (samples # 8-2 and 7-1). These two membranes had different modification histories, as shown in Table 2. The magnification was not high enough to see pores, even though the surface textures of the samples were different. However, it is clear that coverage of the pores by interfacial polymerization for membrane # 7-1 was more than that for membrane # 8-2, which correlated with higher gas permeance for #7-1 membrane. However, the ethanol permeabilities of these membranes were close. The SEM magnification strictly depends on the effectiveness of surface charge removal. Carbon-based coating to help with surface charge removal was not effective, since a high level of charged groups was present on the membrane surface. These charged groups were a product of poly(ethyleneimine)-based interfacial polycondensation.

The values of the average pore radii of bare polypropylene flat film and the modified samples were estimated from nitrogen permeance and ethanol permeability (ethanol viscosity at 25° C. was taken as 1.074*10⁻³ Pa*s). Values are provided in Table 3 and compared with those from the SEM data and previously obtained measurements.

TABLE 3
Estimated Average Effective Radii of Polypropylene
Flat Films Without Modification And Modified
By Interfacial Polymerization, nm

| | | N₂ permeation^{†} | | Ethanol permeability^{††} | |
|---|---|---|---|---|---|
| Sample# | SEM | εₛ = 0.137 | εₛ = 0.110 | εₛ = 0.137 | εₛ = 0.110 |
| 6-2 | — | 1.0 | 1.2 | 2.2 | 2.4 |
| 6-4 | — | 0.70 | 0.90 | 2.5 | 2.8 |
| 7-1 | — | 1.5 | 1.9 | 2.4 | 2.7 |
| 7-2 | — | 0.43 | 0.50 | 2.0 | 2.2 |
| 8-2 | — | 1.7 | 2.2 | 2.8 | 3.2 |
| 8-3 | — | 2.2 | 2.8 | 3.5 | 3.8 |
| Bare PP | 26 | 30 | 37 | 23 | 26 |
| flat | (31^{††††}) | | | 24^{†††††} | 27^{†††††} |
| film^{†††} | | | | | |

^{†}For ΔP = 6-7 psi (41-48 kPa)
^{††}ΔP = 15 psi (103 kPa), larger surface porosity (εₛ) was found as per equation (6); lower value of εₛ was calculated from SEM pictures
^{†††}Celgard 2400
^{††††}From Celgard product information data
^{†††††}From iso-propanol permeability data

Effective pore size for a bare polypropylene flat membrane obtained from gas permeance results (where εₛ=0.11) was close to the value calculated from Celgard information data. For εₛ=0.137, the pore radius was even larger. Liquid permeability-based results were close to or lower than SEM data estimates. For all modified membranes, pore radii estimated from liquid permeability were larger than that of FT-30 membrane (bimodal distribution with two maximums at about 0.75 and 0.95 nm). It was observed that for modified membranes, radii calculated from liquid permeability values were larger than those obtained from gas permeance.

The noted differences may be due to specific interactions of the interfacially polymerized, poly(ethyleneimine)-based layer with the solvent. Further, the coating may become more porous (swollen) after wetting with ethanol. This effect may not cause further pore opening as can be seen from the flux vs. pressure dependence shown in FIG. 1.

In the experimental studies reported herein, increasing pressure did not result in an increase in permeability. Indeed, the behavior was similar to that of bare polypropylene flat film, i.e., the curves were bent outward from the ordinate axis signifying compression effects at higher pressures. Also, the range of flux variation for ethanol permeability (32 times) was limited compared to that for gas permeance (470 times) (see Table 2). The corresponding variation in the pore radii from the gas permeance data was about 5 times. For liquid permeance, such variation was less than two times (see Table 3). Also, for membrane samples #6-4 and 7-2, the discrepancies in pore radii found from gas permeance and liquid permeabilities were the largest. Of note, defects in the membrane may cause discrepancies in pore radii. Swelling of the crosslinked poly(ethyleneimine) coating was about 1%. Thus, swelling alone may not explain the noted discrepancies.

Solvent flux and zein rejection measurements for bare and coated membranes on both X-10 and X-20 hollow fibers are shown in Table 4 along with each membrane's interfacial polymerization modification history. The pore dimensions of polypropylene X-10 and X-20 hollow fiber membranes were similar to those of the polypropylene flat films shown in FIG. 2.

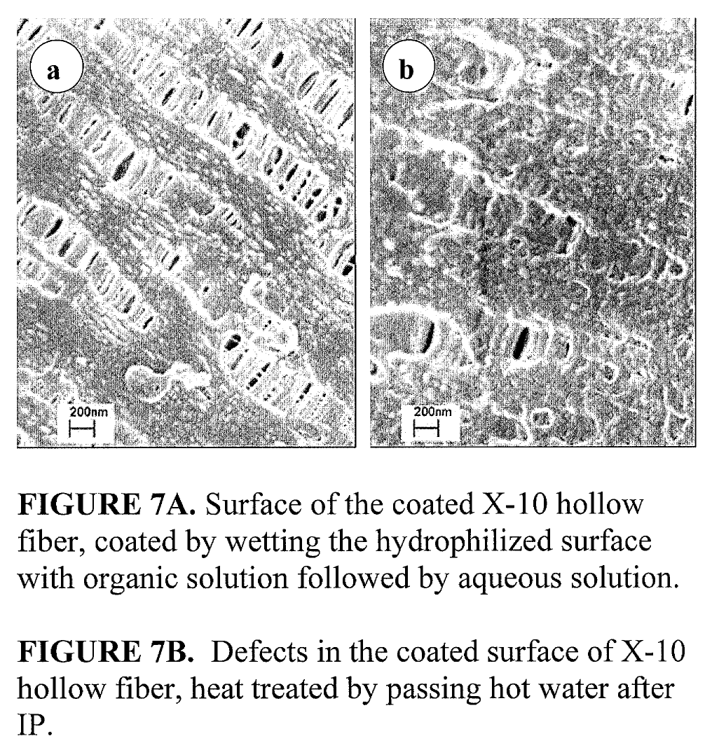

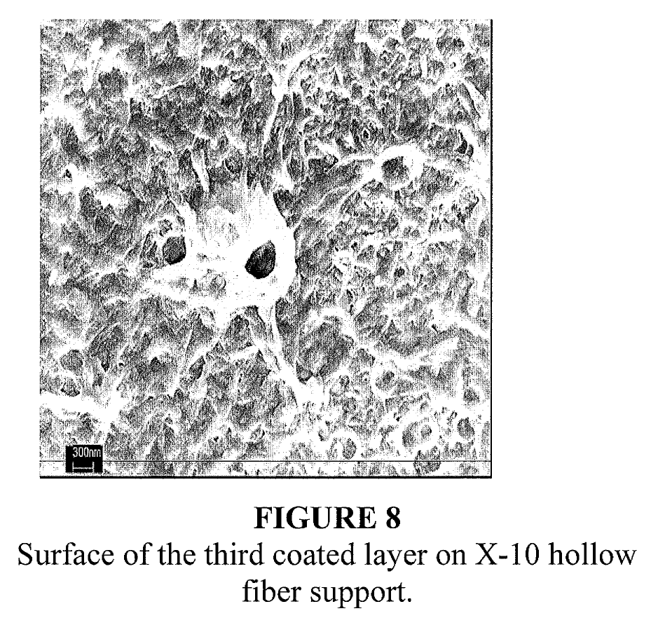

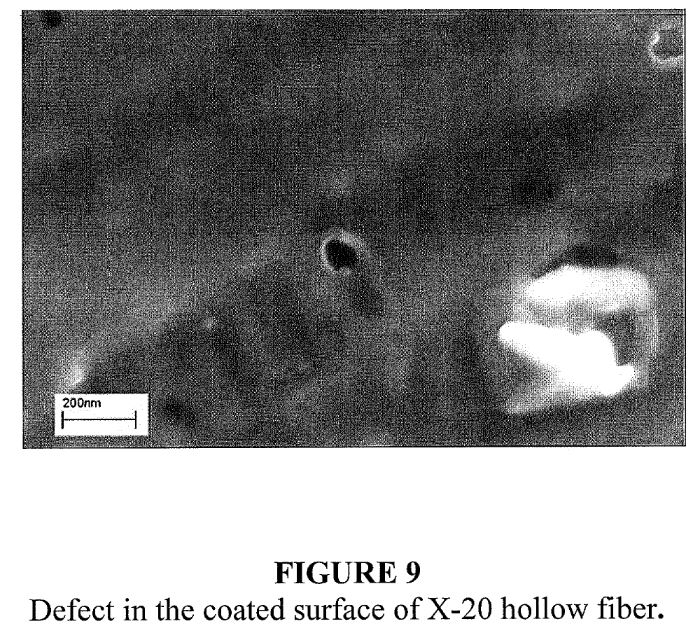

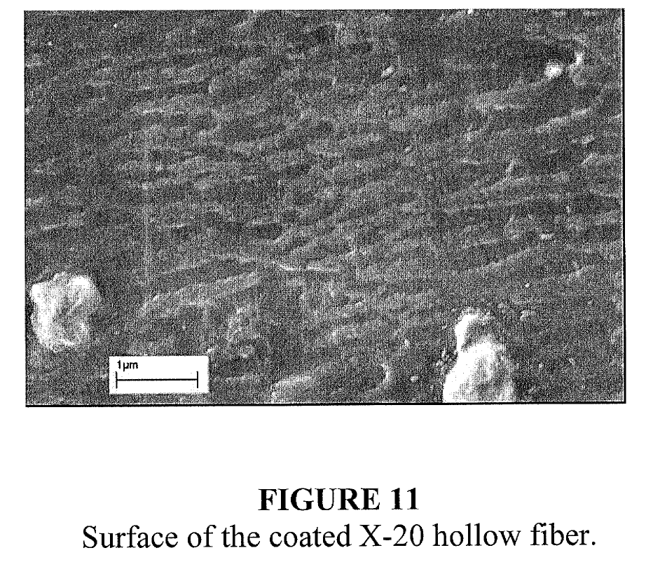

TABLE 4
Solvent Flux and Zein Rejection in Hollow Fiber Membranes

| | Solvent flux* | Zein | SEM | Reactants'^{†††} | Polymerization |
|---|---|---|---|---|---|
| Membrane | cm³/(cm² · s) | rejection, % | picture | concentrations | time |
| X-10 (bare) | 4*10⁻⁴ | 0 | Similar to | — | — |
| X-20 (bare) | 8*10⁻⁴ | 0 | FIG. 2 | — | — |
| X-10^{†} | 3.9*10⁻⁴ | 11 | FIG. 7a | 1 wt. % SC | 1.5 min |
| | | | | 1 wt. % HD | |
| X-10^{††} | 18*10⁻⁶ | 97 | FIG. 8 | 2 wt. % SC | 2.5 min |
| | | | | 2 wt. % HD | |
| X-20 | 53*10⁻⁶ | 73 | FIG. 9 | 0.5 wt. % PEI | 10 min |
| | | | | 0.5 wt. % IPD | |
| X-20 | 4.2*10⁻⁵** | 91 | FIG. 11 | 0.5 wt. % PEI | 10 min |
| | | | | 0.5 wt. % IPD | |

*At 52 kPa
**At 138 kPa
^{†}Coated by wetting the hydrophilized surface with the organic solution followed by the aqueous solution
^{††}Three layered coating, contact time was the same for each layer as specified
^{†††}SC—sebacoyl dichloride, HD—1,6-hexanediamine, IPD—iso-phthaloyl dichloride, PEI—poly(ethyleneimine)

Polypropylene X-10 hollow fiber modules were first modified by the reverse interfacial polymerization procedure described above. Of note, only the diamine monomer can partition into the organic solvent, but dichloride monomer cannot partition into water. Hence, the thin film is formed in the organic phase. For this reason, the support was wetted with the organic monomer containing solution after hydrophilization because the interfacial polymerization layer formed in the organic phase binds more effectively to the support. However, the membrane module coated by the above procedure offered only 11% rejection for zein with no reduction in the solvent flux. A SEM picture of the coating (FIG. 7a) looked very similar to the support membrane, indicating that there was no coating.

In this regard, wetting the support with an organic solution after hydrophilization may invert the hydrophilized groups initially created on the surface of the support toward the interior of the support and, hence, the coating may not bind to the support. Thus, although there will be coating formation during the interfacial polymerization process, the coating may be washed away during the characterization studies. Thus, for the remaining experiments described herein, the inner surfaces of the fibers were first wetted with aqueous monomer solution before passing the organic monomer solution.

Different modes of heat treatment have been studied according to the present disclosure using two weight % monomer concentrations with a reaction time of 2.5 minutes. SEM pictures and characterization by zein rejection may be used to indicate/identify defects (if any) in the membrane. For example, heat treatment by passing hot water through the fibers immediately after the interfacial polymerization process has been found to produce a number of defects (FIG. 7b). These defects may result from the drag created on the nascent interfacial polymerization film by the flow of hot water. The coated fibers may be coated again by the same procedure as the first coating without the hydrophilization step. In this regard, the hydrophilization step was not needed because the polyamide coating was already hydrophilic. For example, recoating of the fibers resulted in a 97% rejection of zein after the third layer of coating. An SEM image of this layer of the membrane is shown in FIG. 8. Although this image shows some defects in the third coated layer, it appears that these defects are covered with non-defective sections of second and first layers, resulting in effective rejection of zein protein. In exemplary embodiments, effective rejection of zein was achieved after three layers of coating and the solvent flux was advantageously reduced by a factor of 22 times as compared to the support membrane.

Since polypropylene X-20 hollow fibers were available in larger inner diameters than X-10 fibers, further studies were carried out on X-20 fibers. The interfacial polymerization procedure was as described above. Zein rejection in this coated membrane was 73% (Table 4) and solvent flux was advantageously reduced by a factor of 15 times as compared to the support membrane. The coating for X-20 hollow fibers was uniform. Some minor defects were still observed in the SEM pictures, however. (FIG. 9)

For example, FIG. 8 shows some defects, which may explain the lower zein rejection (73%). Effective zein rejections (91%) were achieved following the same procedure and using the same experimental conditions on X-20 fibers. In exemplary embodiments, defects in the coating may be reduced by removing the excess monomers from inner surfaces of the fibers and coating the membranes. Removal of the monomers may be accomplished in various ways, e.g., using air flow through the membrane.

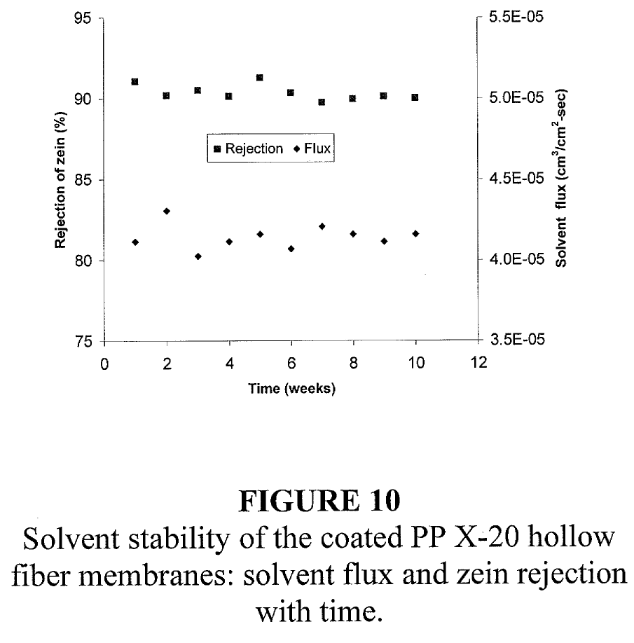

Solvent stability of coated membranes has also been studied according to the present disclosure and the results are presented in FIG. 10. Both the zein rejections and the solvent fluxes were stable for an experimentally studied period of 10 weeks, indicating that the coated membranes are stable in ethanol solutions.

For example and with reference to FIG. 11, the coating on X-20 hollow fiber membranes was very uniform and appeared very similar to that of the coating on flat films (shown in FIG. 5). Although the reaction time was 10 minutes, the coating thickness was less than 0.1 μm. The impressions of the support pore structure were recorded in FIG. 9. The bulkiness of the poly(ethyleneimine) polymer may explain a difference in behavior from coatings formed using 1,6-hexanediamine. The flow involved during the interfacial polymerization process was minimized by stopping the flow of the organic monomer solution, creating a situation similar to the coating on flat films. In exemplary embodiments, a larger inner diameter may help reduce defects in the coating. For example, the larger inner diameter of the X-20 fibers helped reduce defects in the coating by reducing the shear on the nascent polyamide film at the time of removal of organic solution after polymerization.

Of note, treating the formed coating with heat may be effective to cause 0.5 wt % of poly(ethyleneimine) present in the pores of the support to self-crosslink and insolubilize in the pores. Self-crosslinking of poly(ethyleneimine) may partially hydrophilize the support.

To study the hydrophilicity of the support and the coating, polyamide coated X-20 fibers were tested for water permeability according to the present disclosure by flowing water through the lumen side at 10 psig (69 kPa). Water permeability was 2*10⁻⁵ cm³/cm²·sec and was 2.6 times lower than the 70% ethanol permeability measured at a slightly lower pressure difference of 52 kPa. Observed water permeability was minimal when water was pressurized from the non-coated side (i.e., the outer surface) of the coated X-20 fibers. Thus, in exemplary embodiments, the coating may be considered hydrophilic and the pores of the support may be only partially hydrophilic.

In exemplary embodiments, the disclosed polypropylene support of the coated X-10 fibers may be completely hydrophobic, unlike the support of coated X-20 fibers. For example, water did not permeate when it was pressurized at 10 psig (69 kPa) from the lumen side of the three layered coated module of X-10 hollow fibers coated with 1,6-hexanediamine and sebacoyl chloride. In these experiments, 1,6-hexanediamine did not self-crosslink during heat treatment and/or insolubilize in the pores of the support like poly(ethyleneimine).

In exemplary embodiments of the present disclosure, thin film composite membranes on polypropylene hollow fibers and flat films may be successfully prepared by interfacial polymerization on a polypropylene support. The support may be hydrophilized on a preliminary basis by pre-wetting the membranes with acetone, followed by oxidation with a hot chromic acid solution or any other oxidizing solution. Thus, uniform hydrophilization of both the pore mouth and the interior of the hydrophobic support may be achieved. In exemplary embodiments, the hydrophilized support may first be treated with an aqueous monomer-containing solution, followed by treatment with an organic monomer-containing solution. In an alternative embodiment, an organic monomer-containing solution may be introduced first, followed by an aqueous monomer-containing solution when treating a hydrophilized support.

Solvent permeation and gas permeation measurements have been used to estimate the average effective pore radius of the modified flat films disclosed herein. With such measurement techniques, it has been found that the average effective pore radii vary from 0.4 to 2.8 nm according to gas permeance and from 2.0 to 3.8 nm by ethanol permeability data. In exemplary embodiments, variation in the measured pore radii may be due in part to many factors including, but not limited to, poly(ethyleneimine) swelling.

Interfacially polymerized hollow fiber membranes were further characterized by ultrafiltration measurements of the corn protein, zein, in an alcoholic solution.

In exemplary embodiments, removal of excess monomers during the interfacial polymerization process of hollow fibers may be effectuated by blowing with air at low flow rate. Removal of excess monomers may, in exemplary embodiments, increase the uniformity of the formed coating. Implementation of a heat treatment method may affect coating characteristics including, but not limited to, potential defects in the coating. For example, better coating results have been obtained by heat treatment in an oven compared with heat treatment by passing hot water, hot air and/or curing using ambient air.

Some coating defects may result in lower rejection values for the protein zein. Defect formation may be affected by the size of an inner diameter of the hollow fiber to be treated, as well as the number of coatings deposited. In exemplary embodiments, multiple coatings (e.g., two or more) may increase zein rejection. For example, zein rejections of 97% were achieved after three successive coatings on X-10 hollow fibers. The inner surface area of the hollow fiber may also affect coating characteristics. Larger diameter hollow fibers may reduce the shear created by monomer solution flow on nascent coating. For example, interfacial polymerization carried out on hollow fibers of larger inner diameter (e.g., X-20 hollow fibers) with a single coating resulted in 91% zein rejection. Polypropylene X-20 hollow fibers coated with a monomer system of poly(ethyleneimine) and iso-phthaloyl dichloride appeared to be stable in ethanol solutions.

It has been found according to the present disclosure that, when the monomer system of poly(ethyleneimine) and iso-phthaloyl dichloride was used, the support was additionally hydrophilized with the self cross-linked poly(ethyleneimine) which was forming the selective layer. In exemplary embodiments, the support may remain hydrophobic when 1,6-hexanediamine and sebacoyl chloride are used as monomers.

Gas permeance and liquid permeability of a porous membrane may be defined by:

$${( Q / δ )}_{i} = \frac{{V}_{i}}{{A}_{m} ( {P}_{f} - {P}_{p} )} \qquad ( 1 )$$

where P_{f} and Pₚ are the absolute pressures of pure gas (e.g., N₂) or liquid (e.g., ethanol) on the feed and permeate side, respectively, and Vᵢ is the permeate volumetric flow rate. In exemplary embodiments, nitrogen permeance and ethanol permeability may be used to estimate the average pore size of the dense skin of thin film membranes. The overall permeance (permeability for liquid) and the permeances/permeabilities of the support and the selective layer may be related by the equation;

$$\frac{1}{{( Q / δ )}_{overall}} = \frac{1}{{( Q / δ )}_{1}} + \frac{1}{{( Q / δ )}_{0}} \qquad ( 2 )$$

where (Q/δ)overall, (Q/δ)₁ and (Q/δ)₀ are the permeances/permeabilities of the overall composite, the selective layer and the support (e.g., bare polypropylene flat membrane), respectively; and δ is the thickness of the membrane/membrane layer estimated from SEM analysis of the cross-section of a thin film composite sample.

The equation for the mass rate of Knudsen flow of a gas, kg/s, through a single straight pore is:

$$w = \sqrt{\frac{2 M}{π RT}} ( \frac{4}{3} π {r}^{3} ) \frac{Δ P}{L} \qquad ( 3 )$$

where M is the molecular mass of the gas, R is the universal gas constant, T is the absolute temperature, r is the pore radius, and ΔP=P_{f}−Pₚ is the pressure difference across the pore of length L. The corresponding expression for the molar flux, mole/(m²*s), across the membrane of area Aₘ, thickness δ and characterized by nₚ, the number of pores with average pore radius r and pore tortuosity of π, is:

$$J = \sqrt{\frac{2 M}{π RT}} ( \frac{4}{3} π {r}^{3} ) \frac{{n}_{p}}{{M}_{τ} {A}_{m}} \frac{Δ P}{δ} = \frac{4 r {ɛ}_{s}}{3 τ} \sqrt{\frac{2}{π RTM}} \frac{Δ P}{δ} = {k}_{m} Δ P \qquad ( 4 )$$

Here ε^{s} is membrane surface porosity and km is the gas permeance across the membrane, expressed in mol/(m²*s*Pa). It is related to the gas permeance through the membrane (Q/δ) expressed in cm³(STP)/(cm²*s*cm Hg):

$${k}_{m , {CO}_{2}} ( \frac{mol}{{m}^{2} \cdot s \cdot Pa} ) = ( \frac{Q}{δ} ( \frac{{cm}^{3} ( STP )}{{cm}^{2} \cdot s \cdot cm Hg} ) ) \cdot ( \frac{{T}_{0} \cdot {( 22400 )}^{- 1} \frac{mol}{{cm}^{3}}}{T \cdot {10}^{- 4} \frac{{m}^{2}}{{cm}^{2}} \cdot 1.333 \cdot {10}^{3} \frac{Pa}{cm Hg}} ) = ( \frac{Q}{δ} ) \cdot 3.35 \cdot {10}^{- 4} \cdot \frac{{T}_{0}}{T} \qquad ( 5 )$$

where T₀=273.16K and T is the experimental temperature in Kelvin.

The surface porosity, εₛ) and the volume (bulk) porosity, ε, are assumed to be related by the equation:

$$ɛ = \frac{{n}_{p} \cdot {A}_{p} \cdot δ \cdot τ}{{A}_{m} \cdot δ} = {ɛ}_{s} \cdot τ \qquad ( 6 )$$

where terms nₚ·Aₚ·δ·π and Aₘ·δ represent, respectively, the void volume and the total volume of the membrane (equal to the sum of the void volume and the volume occupied by the polymer). Therefore, for a support of known porosity and thickness δ₀, the average effective radius of the pore, r₀, approximated as having a circular cross section, can be expressed from equations (4) and (5) for a non-modified film/support as follows:

$${r}_{0} = {( \frac{Q}{δ} )}_{0} \cdot 3.35 \cdot {10}^{- 4} \cdot \frac{{T}_{0}}{T} \cdot \frac{3 τ {δ}_{0}}{4 {ɛ}_{s}} \sqrt{\frac{π RTM}{2}} \qquad ( 7 )$$

Assuming that a membrane with pore size estimated according to the equation (7) is modified in a such way that all pores are reduced in size but the pore number density (number of pores per membrane unit area) is the same as that in non-modified membrane, then, with (Q/δ)₁ found from equation (2), the ratio of the gas permeances of a selective layer of modified membrane to the bare one is expressed from equation (4);

$$\frac{{( \frac{Q}{δ} )}_{1}}{{( \frac{Q}{δ} )}_{0}} = \frac{{r}_{1}^{3}}{{r}_{0}^{3}} \frac{{δ}_{0} {τ}_{0}}{{δ}_{1} {τ}_{1}} \qquad ( 8 )$$

Here r₁, δ₁ and π₁ are for the selective layer developed on top of the bare support. Assuming the selective coating layer is characterized by the value of π₁=1, the average pore radius r₁ is found from equation (8) as follows:

$${r}_{1}^{3} = \frac{{( \frac{Q}{δ} )}_{1}}{{( \frac{Q}{δ} )}_{0}} \frac{{δ}_{1}}{{δ}_{0} {τ}_{0}} {r}_{0}^{3} \qquad ( 9 )$$

For Poiseuille flow of a liquid through a porous membrane, the volumetric flux N (m³/(m*s)) across the membrane may be expressed as:

$$N = \frac{π {n}_{p} {r}^{4}}{8 μτ {A}_{m}} \frac{Δ P}{δ} = \frac{{ɛ}_{s} {r}^{2}}{8 μτ} \frac{Δ P}{δ} = ( \frac{Q}{δ} ) \cdot Δ P \qquad ( 10 )$$

where μ is the liquid viscosity. In a manner analogous to that for gas transport in Knudsen flow, the average effective pore radius of the porous support is derived from equation (10) as:

$${r}_{0}^{2} = {( \frac{Q}{δ} )}_{0} \cdot \frac{8 {μτδ}_{0}}{{ɛ}_{s}} \qquad ( 11 )$$

The average effective pore radius in the selective layer obtained by interfacial polymerization is found from the permeability ratio in the same way as for Knudsen flow:

$${r}_{1}^{4} = \frac{{( \frac{Q}{δ} )}_{1}}{{( \frac{Q}{δ} )}_{0}} \frac{{δ}_{1}}{{τ}_{0} {δ}_{0}} \cdot {r}_{0}^{4} \qquad ( 12 )$$

The value of (Q/δ)₁ is obtained from equation (2) knowing experimentally values of (Q/δ)₀ for the non-modified membrane and (Q/δ)ₒᵥₑᵣₐₗₗ for the overall composite.

Poly(ethyleneimine) has been used as a multifunctional amine for preparation of RO membrane NS-100. Commercial poly(ethyleneimine) (see structure below) is:

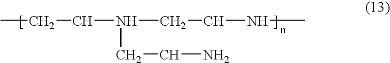

obtained by ring-opening polymerization of ethyleneimine and has a substantial degree of branching and a ratio of primary:secondary:tertiary amines as 3:4:3. This polymer is available in the molecular weight range between 600 and 70,000. RO membranes may be optimized when polymers having a molecular weight in a range from about 10,000 to about 60,000 are used. This polyfunctional amine possesses a high free energy of adhesion of 191 J/mol that allows its use in a variety of applications such as adhesives, flocculating agents, ion exchange resins, absorbents, etc., and has applicability for surface treatment of polymers, including PP, with preliminary surface modification by air corona discharge.

The free energy of adhesion (energy per unit area) between two dissimilar phases can be presented as:

W_{A}=W_{AD}+W_{AP} (14)

where W_{AD} and W_{AP} are the dispersion and polar components, respectively (in the noted case, the last term is for dipole-dipole interactions). Therefore, creating polar groups on the support surface may substantially improve adhesion between the support and the selective layer containing polar groups itself.

In exemplary embodiments of the present disclosure, use of an organic liquid, such as acetone, to wet the pores of polypropylene before treatment with an oxidizer (e.g., chromic acid) is beneficial for several reasons. In particular, acetone is miscible with water and is hard to oxidize because it is a ketone. Moreover, acetone is an aprotic solvent. In exemplary embodiments, the concentration and/or amount of acetone may be controlled to reduce the effect of the acetone on the oxidizing properties of the oxidizer. The very edge of the membrane pore may be hydrophilized as well as the between-pore polymer portion of the membrane. In addition, in exemplary embodiments of the present disclosure, attaching a selective layer close to the membrane pore edge may advantageously increase attachment of the selective layer to the support.

Another example of the method of interfacial polymerization of a polyolefin membrane according to the present disclosure is described below. In exemplary embodiments, flat polypropylene membranes were subjected to a “modified interfacial polymerization” procedure. Different solutions were passed through the pores of the flat membranes during the modification process. An apparatus that included a glass porous support and a reservoir was used to support the membrane. The membrane was clamped between the porous support and the reservoir. Vacuum was pulled through the porous support to pull the solutions (monomer solutions/water/chromic acid solution) through the membrane.

Polypropylene flat membranes were first hydrophilized by treating with hot chromic acid solution. Concentration and treatment times were the same as those described with reference to the disclosed flat membranes hydrophilized for interfacial polymerization. An alternative hydrophilization procedure was employed. In particular, to hydrophilize the entire pore interior of polypropylene flat films, membranes were pre-wetted with acetone and chromic acid solution was forced through the membranes using the set-up described above.

Membranes hydrophilized by the chromic acid treatment were washed with water for 20 minutes. Then, pores of the membrane were filled with an amine monomer dissolved in water (e.g., in a range from about 0.5 weight % to 6 weight % of PET). The membranes were next dried by pulling vacuum for 5 hours. Then, the membranes were soaked in an organic monomer-containing solution (0.5 to 2 wt. %) for ten minutes to coat the pore interior and the surface of the membrane with the hydrophilic polyamide reaction product. After polymerization, the modified membranes were heat treated in an oven at 110° C. for 20 minutes.

Modified membranes were characterized by measuring the breakthrough pressures for water and the water permeation rates using a flat membrane cell having 7 cm² membrane area. Water permeation and breakthrough pressures were measured without any pre-wetting (e.g., based on a pre-wetting agent such as ethanol or acetone). For breakthrough pressure measurements, the applied pressure was increased in steps of about 5 psi (34.5 kPa). The membrane cell was the same as the membrane cell used for other flat membrane studies described above.

Breakthrough pressures for water and the water permeation rates for flat films modified with the objective of permanent hydrophilization are provided in Table 5.

TABLE 5
Breakthrough Pressures and Water Flux in Polypropylene
Flat Membranes Modified with “Modified Interfacial
Polymerization” Procedure

| Reactants | Breakthrough pressure | Water permeation |
|---|---|---|
| concentrations | (kPa) | (cm³/(cm² s)) |
| 0.5 wt. % PEI, | >448 | — |
| 0.5 wt. % IPD | | |
| 2 wt. % PEI, | Between 310 and 345 | 18.3 *10⁻⁶ at 345 kPa |
| 2 wt. % IPD | | |
| 3 wt. % PEI, | Between 241 and 276 | 33*10⁻⁶ at 276 kPa |
| 2 wt. % IPD | | |
| 6 wt. % PEI, | Between 379 and 414 | 9.9*10⁻⁶ at 414 kPa |
| 2 wt. % IPD | | |

As the concentration of PEI for the modification was increased from 0.5 weight % to 3 weight %, the breakthrough pressures for water was decreased. When the PEI concentration was further increased to 6 weight %, the breakthrough pressure was increased and this phenomenon may be explained as follows. At high PEI concentrations (i.e., about 6 weight %) PEI was most likely to have covered the surface of the flat film instead of being deposited only on the pore interior after the removal of water. As a result, a thin film composite membrane was formed and the breakthrough pressure was increased.

In another experiment according to the present disclosure, an interfacial polymerization method was used to prepare a membrane for nanofiltration. Polypropylene X-20 hollow fiber modification was carried out with 0.75 weight % aqueous poly(ethyleneimine) solution (i.e., amine reactant) and 0.75 weight % iso-phthaloyl dichloride (i.e., diacyl chloride reactant) solution in xylene. The organic monomer solution was kept standing still inside the lumen of the fibers during the interfacial polymerization process. Organic solution was initially passed through the fibers positioned in a module holding the fibers in a vertical orientation. When the organic solution appeared at the other end of the module, the flow of the organic solution through the fibers was stopped. After a period of up to 10 minutes, considered as the reaction time, the organic solvent was removed from fibers and the excess was removed by blowing gently with air. Then, the coating was heat treated by placing the module in an oven at 110° C. for 20 minutes. Membranes were then characterized using a feed solution of about 0.01% of Brilliant blue R (having a molecular weight of 826) in methanol. Measurements of solute rejection and solvent flux were taken at a pressure of about 60 psi (i.e., 413.7 kPa). The resulting membrane showed a rejection of solute equal to about 88%. The solvent flux of methanol was measured at 16.9×10⁻⁵ cm³/(cm²-s).

In a further nanofiltration membrane example according to the present disclosure, polypropylene Celgard X-20 hollow fiber membranes were coated on the lumen side of the fibers by a reactive monomer system of poly(ethylenimine) (PEI) and iso-phthaloyl dichloride (IPD). The coating procedure was optimized to minimize the time involved in the coating process and to achieve a defect-free coating. Safranin O (MW 351) and brilliant blue R (MW 826) in methanol were used as solutes to characterize the fabricated membranes and long term solvent stability of the coated membranes was studied in toluene. Of note, it is generally convenient to coat and characterize flat sheet membranes rather than hollow fiber membranes. Accordingly, some of the characterization studies described herein, such as pressure dependence on solvent flux, water flux and solute rejection, were performed with flat sheet membranes.

### Membranes and Materials

Sulphuric acid (95.7% purity ACS reagent, Sigma-Aldrich, St. Louis, Mo.), potassium dichromate (99% purity ACS reagent, Sigma-Aldrich, St. Louis, Mo.) and acetone (99% purity, Fisher Scientific, Suwanee, Ga.) were used in the polypropylene hydrophilization process. The reactive monomers used for interfacial polymerization were an aqueous solution of 50 wt % poly(ethylenimine) with polymer average MW between 50,000 and 60,000 (Fisher Scientific, Suwanee, Calif.) and iso-phthaloyl dichloride (Sigma-Aldrich, St. Louis, Mo.). Solutes used for the characterization of the TFC membranes were safranin O (dye content 95%, Fisher, Fair Lawn, N.J.), brilliant blue R(dye content 90%, Sigma Aldrich, St. Louis, Mo.) and Zein (Freeman industries, Tuckahoe, N.Y.). Solvents used in the study were methanol, toluene and xylene (Fisher, Fair Lawn, N.J.).

### Membranes

Hollow fiber membrane modules were fabricated using Celgard X-20 hollow fibers (Celgard, Charlotte, N.C.). The fabricated hollow fiber membrane modules were coated on the lumen side. Characteristics of the membrane module are given in Table 6 below. Celgard 2400 flat polypropylene membranes (25 μm thick, porosity 37%, pore size 0.117 μm*0.042 μm, Celgard, Charlotte, N.C.) were used for the studies carried out in flat film membranes.

TABLE 6
Characteristics of X-20 hollow fiber membrane module

| Module characteristics | Values |
|---|---|
| Internal diameter, μm | 400 |
| Wall thickness, μm | 25 |
| Number of fibers | 6 |
| Nominal porosity | 0.4 |
| Effective module length, cm | 12 |
| Effective mass transfer area | 9.0 |
| based on ID, cm² | |

### Fabrication of Thin Film Composite Membranes by Interfacial Polymerization

Flat sheet polypropylene membranes were coated by the procedure described above. The procedure to coat the lumen side of the polypropylene hollow fiber membranes proceeded as follows. The polypropylene hollow fiber membranes were first hydrophilized by pre-wetting with acetone followed by chromic acid treatment. After washing the hollow fibers to remove residual chromic acid with water, an aqueous monomer-containing solution was passed through the lumen side. Then, the excess aqueous solution was removed from the lumen side by purging gently with air at a low flow rate. Next, xylene solution having monomer was introduced from the lumen side at a very low flow rate for the time period equal to the reaction time (10 min) of interfacial polymerization while holding the membrane module vertical. After the excess organic solution from the lumen side was removed in the same way as the aqueous solution for one minute, the coating was heat treated by placing the module in an oven at 110° C. for 20 minutes.

The experimental setup used for hydrophilization, modification and characterization of the hollow fiber membrane modules included a pump connected to the hollow fiber membrane module to pass the solutions through the lumen side and a valve arranged after the hollow fiber module to control the pressure. A peristaltic pump was employed to facilitate the use of different flow lines using the same pump. Different flow lines were used to pass different solutions so that washing of the lines was not required during the hydrophilization/coating process. For example, flow lines for acetone, chromic acid solution, water, aqueous monomer solution and organic monomer solution were different.

### Characterization of the Fabricated Membranes

Hollow fiber membranes were characterized by measuring reduction in the solvent flux and solute rejection. A pump was used to pass the feed solution through the lumen side of the fibers. The valve located at the end of the module was used to pressurize the feed solutions and to control the feed pressure. Permeate was collected through the shell side of the hollow fiber module and analyzed for solute concentration. In addition, coated membranes were characterized by scanning electron microscope (SEM: LEO 1530).

Nanofiltration of solutes (safranin O (MW 351) and brilliant blue R (MW 826) dyes) was studied using the coated membranes at a transmembrane pressure of up to 60 psi (413 kPa). Methanol was used as a solvent for the above-mentioned solutes. Solute concentration in the feed solution was 0.01 wt %. Concentrations of safranin O and brilliant blue R in the permeate were analyzed by the U-2000 UV-VIS spectrophotometer at 530 and 590 nm, respectively.

### Solvent Stability of the Coated Thin Film Composite Membranes

The coated membranes were tested for solvent stability. In particular, stability of the coated nanofiltration membranes with toluene at a transmembrane pressure of 413 kPa was studied as follows: Coated membranes were soaked in toluene continuously for a period of 10 weeks at room temperature; membrane characteristics were studied once per week using a feed solution of 0.01 wt % of brilliant blue R in pure methanol at 413 kPa. Neither brilliant blue R nor safranin O is soluble in toluene. Therefore, methanol was used as a solvent instead of toluene to study the membrane characteristics (solvent flux and solute rejection). Before measuring the membrane characteristics, toluene in the membrane pores was replaced with methanol by pressurizing methanol in the lumen side at a transmembrane pressure of 413 kPa for three hours. Membranes were washed with pure methanol after the solute rejection and solvent flux measurements. Next, methanol in the membrane pores was replaced with toluene before the membrane was soaked in toluene.

### Optimized Coating Procedure

An optimized procedure was developed to provide a defect-free coating on the lumen side of the hydrophobic X-20 polypropylene hollow fibers. Pores of the hollow fibers were first wetted with acetone by passing acetone through the lumen side at 2 psig (115.1 kPa) for 2 minutes. The chromic acid solution (K2Cr2O7, H2O, H2SO4:1, 19, 29.4) at 65° C. was next circulated through the bore of the fibers at 5 psig. After 30 minutes of treatment, the chromic acid solution in the reservoir was replaced with a fresh batch of chromic acid solution. The chromic acid solution was washed with water for 30 minutes at a transmembrane pressure of 10 psi (68.9 kPa). Then, the aqueous monomer solution was passed through the fibers for 30 minutes at 5 psig. The excess aqueous solution from the lumen side was removed by passing air at a flow rate of 1.5 cm³/s and 2 psig (115.1 kPa) for 20 seconds. Next, the organic monomer solution was passed through the fibers at a flow rate of 20*10-3 cm³/s followed by removal of the excess organic solution removal by blowing air at 1.5 cm³/s flow rate and 2 psig (115.1 kPa) for 20 seconds. The coated module was then heat treated in an oven at 110° C. for 20 minutes.

### Nanofiltration

Nanofiltration membranes were fabricated on both the X-20 hollow fiber and flat film membrane supports of polypropylene. Characterization of the coating (solute rejection and solvent flux) and solvent stability studies were carried out in hollow fiber membrane modules. Pressure dependence of the solvent flux in the modified membranes was studied using flat film membranes. As the concentrations of monomers for interfacial polymerization increase, the pore size of the coating will decrease. Hence, membranes were fabricated using higher monomer concentrations and employing an optimized procedure for fabrication of ultrafiltration membranes. The monomer concentrations studied were 0.5 wt %, 0.75 wt %, 1.0 wt % and 2.0 wt %. The same reaction time (10 minutes) was employed for all experiments. The optimized coating procedure described in Section 3.1 was employed to modify the X-20 hollow fiber membranes.

Modification conditions of the hollow fiber membrane modules and coating characteristics studied with methanol solutions of brilliant blue R and safranin O are provided in Table 7 which illustrates the behavior of solute rejection and solvent flux with increase in monomer concentrations of the coating.

TABLE 7
Behavior of solute rejection and solvent flux (measured
at 413 kPa) with increase in monomer concentrations used
for coating in hollow fiber membrane modules

| | Feed solution: 0.01 wt % of | | Feed solution: 0.01 wt % of | |
|---|---|---|---|---|
| | brilliant blue R in methanol | | safranin O in methanol | |
| | | Methanol | | Methanol |
| | Brilliant | flux | Safranin | flux |
| Reactants | blue R re- | (cm³/ | O re- | (cm³/ |
| concentrations | jection (%) | (cm² · s)) | jection (%) | (cm² · s)) |
| 0.5 wt % PEI | 79 | 1.83*10⁻⁴ | 38 | 1.81*10⁻⁴ |
| 0.5 wt % IPD | | | | |
| 0.75 wt % PEI | 88 | 1.69*10⁻⁴ | 43 | 1.69*10⁻⁴ |
| 0.75 wt % IPD | | | | |
| 1.0 wt % PEI | 88 | 1.38*10⁻⁴ | 45 | 1.40*10⁻⁴ |
| 1.0 wt % IPD | | | | |
| 2.0 wt % PEI | — | — | 45 | 0.95*10⁻⁴ |
| 2.0 wt % IPD | | | | |

Rejection of brilliant blue R in the membrane coated with 0.5 wt % of monomers was 78%. With an increase in concentration of the monomers used for the coating to 0.75 wt %, the rejection of brilliant blue R was increased to 88%. Rejection was not further improved with increase in monomer concentrations to 1 wt %. However, the solvent flux was gradually reduced with increases in monomer concentrations used for coating.

Rejection of safranin O was increased from 38% to 43% when the monomer concentrations for the coating were increased from 0.5 wt % to 0.75 wt %. Safranin O rejection in the membranes coated with 0.75 wt %, 1.0 wt % and 2 wt % monomer concentrations were nearly the same. These solute (brilliant blue R and safranin O) rejection results indicate that only a limited variation in pore size of the coating can be achieved by varying the concentrations of the monomers for the studied reactive monomer system of poly(ethylenimine) (PEI) and iso-phthaloyl dichloride (IPD).

The values of methanol flux (Table 7) achieved in the membranes were the same with both the feed solutions of brilliant blue R in methanol and safranin O in methanol, based on the fact that the feed solutions had very low dye concentrations (0.01 wt %). Of note, the steady state flux of methanol obtained by Whu et al. in commercially available nanofiltration membranes having a 400 molecular weight cut off (MWCO) for a feed solution of 0.01 wt % of safranin O in methanol at 1034 kPa was 1.97*10-4 cm³/(cm²s) [Whu, J. A.; Baltzis, B. C.; Sirkar, K. K., Nanofiltration studies of larger organic microsolutes in methanol solutions. J. Membr. Sci. 2000, 170, 159-172]. The solvent flux values normalized with the pressure in the membranes fabricated according to the present disclosure were about two times higher than the normalized solvent flux in the commercial membrane having a 400 MWCO.

To better understand the nature of the coating, rejection of zein (corn protein having MW of 35,000, soluble in 70-80% alcohol solutions) was also studied in the hollow fiber membranes coated with 0.75 wt % monomer concentrations. A zein rejection of 97% was achieved with a solvent (70% ethanol) flux of 1.17*10−4 cm³/(cm².s) at a transmembrane pressure of 413 kPa. Flux of methanol in the same membrane was 1.69*10−4 cm³/(cm²s). The zein rejection and solvent flux in the membranes coated with 0.5 wt % monomer concentrations measured at 413 kPa were respectively 97% and 1.36*10−4 cm³/(cm²s). At 138 kPa, the zein rejection and solvent flux in the same membranes were 91% and 53*10-6 cm³/(cm²·s), respectively. Therefore, zein rejection was increased from 91% to 97% when the transmembrane pressure was increased from 138 kPa to 413 kPa.

The coating on X-20 hollow fiber membranes with PEI and IPD was very uniform. Although the reaction time was 10 minutes, the coating thickness was less than 0.1 μm. Coating with the reactive monomer system of PEI and IPD was also very smooth.

Fouling is a prominent membrane phenomenon in membrane processes which decreases the membrane flux and reduces the membrane separation efficiency. Fouling increases with an increased roughness of the membrane surface; hence, one would like to produce a coating having a smooth surface. From this perspective, the reactive monomer system of PEI-IPD is advantageous over other reactive monomer system as it produced a very smooth coating.

### Effect of Applied Pressure on Solvent Flux and Solute Rejection in Thin Film Composite Membranes

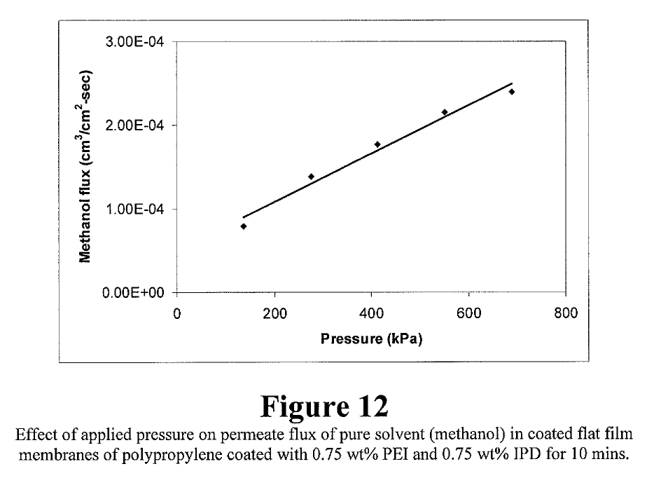

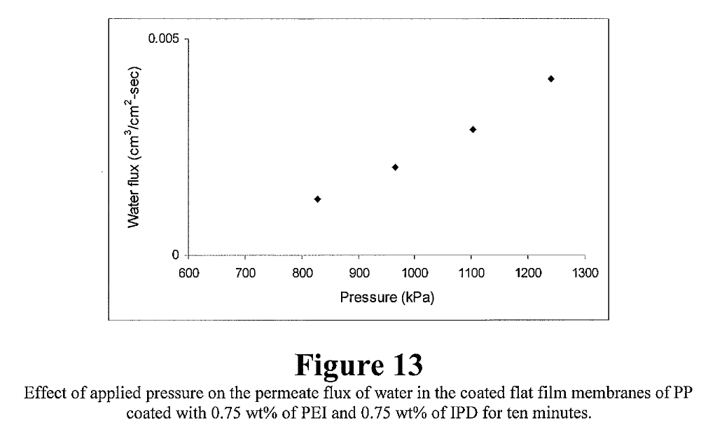

Pure solvent (methanol) flux dependence on transmembrane pressure (138 kPa to 689 kPa) was studied using coated flat film membranes rather than hollow fiber membrane modules because of the capability of the flat membrane cell to withstand higher pressures. Pure solvent flux was studied instead of the solvent flux for a dye (brilliant blue R or safranin O) solution so that the effect (if any) of the solute can be neglected. FIG. 12 illustrates the effect of applied pressure on the permeate flux of a pure solvent (methanol) in the polypropylene flat film membrane coated with 0.75 wt % PEI and 0.75 wt % IPD for ten minutes (88% rejection of brilliant blue R was achieved in the hollow fiber membranes modified with the same coating conditions of monomer concentrations and polymerization time). Water flux increased linearly with the applied transmembrane pressure (FIG. 13). Results in FIG. 12 and FIG. 13 indicate that solvent flux increased linearly with transmembrane pressure in the studied pressure range. This observed behavior follows the commonly observed linear relation between the flux and the transmembrane pressure in the absence of a solute [see, e.g., Scarpello, J. T.; Nair, D.; Freitas dos Santos, L. M.; White, L. S.; Livingston, A. G., “The separation of homogeneous organometallic catalysts using solvent resistant nanofiltration,” J. Membr. Sci. 2002, 203, 71-85]. This linear relation also indicates that there was no pore deformation at higher transmembrane pressures.

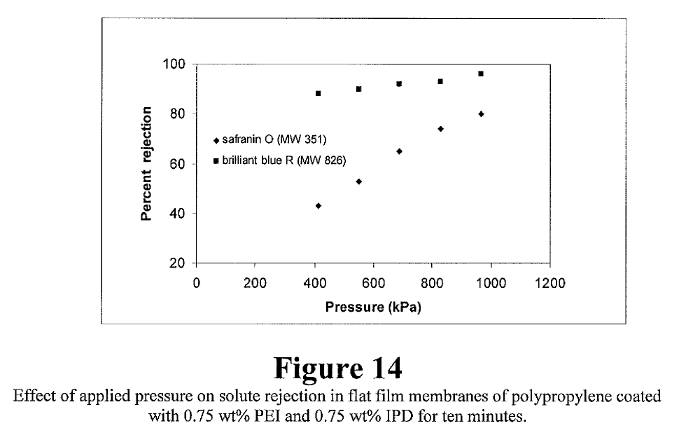

Effect of applied pressure on the solute rejection in the flat film membranes of polypropylene coated with 0.75 wt % PEI and 0.75 wt % IPD for ten minutes is depicted in FIG. 14. Rejection of both solutes (safranin O and brilliant blue R) increased with increase in transmembrane pressure in the flat film membranes coated with 0.75 wt % monomer concentrations for ten minutes. It is believed that transport mechanism in nanofiltration membranes follows the solution-diffusion model. This model predicts that the solute rejection increases with an increase in pressure. In the solution-diffusion model, the solute flux is independent of the applied pressure at high solute rejections and solvent flux is proportional to the applied pressure. As a result, rejection increases at higher pressures. Whu et al. has also reported that rejection of safranin O in a nanofiltration membrane with 400 MWCO was increased from 45% to 87% with an increase in the transmembrane pressure from 1517 kPa to 3034 kPa [Whu, J. A.; Baltzis, B. C.; Sirkar, K. K., “Nanofiltration studies of larger organic microsolutes in methanol solutions,” J. Membr. Sci. 2000, 170, 159-172].

### Solvent Stability of the Thin Film Composite Membranes

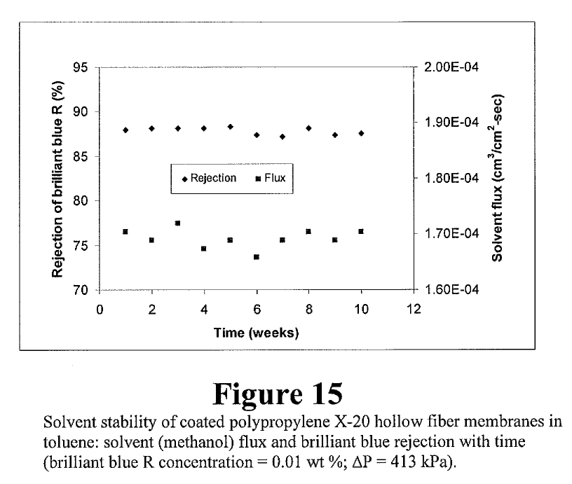

The methanol flux and brilliant blue R rejection values were stable for the studied period of ten week's exposure to toluene (FIG. 15). The coated membranes retained their characteristics with a long exposure to toluene. These results indicate that the polyamide coating on polypropylene support is stable when exposed to a wide range of solvents (alcohols and aromatic hydrocarbons). Kim et al. have reported that in short term stability studies, polyamide coating on polyacrylonitrile ultrafiltration support membrane was solvent resistant to a wide variety of solvents such as alcohols, ketones and hexane [Kim, I.-C.; Jegal, J.; Lee, K.-H., Effect of aqueous and organic solutions on the performance of polyamide thin-film-composite nanofiltration membranes. J. Polym. Sci. 2002, 40, 2151-2163]. Therefore, the membranes fabricated using a polyamide coating on polypropylene support will provide solvent stability over a wide range of solvents in extended runs.

### Experimental Conclusions

Thin film composite membranes on polypropylene hollow fibers and flat films were successfully prepared by interfacial polymerization on the porous polypropylene support. The coating procedure to coat X-20 hollow fiber membrane modules was optimized for defect-free and uniform coating. Coated hollow fiber membranes were characterized by nanofiltration of brilliant blue R in methanol and safranin O in methanol. Only a limited variation in pore size of the coating could be achieved by varying the concentrations of the monomers for the studied reactive monomer system of PEI-IPD. Rejection values of 88% and 43% were achieved for brilliant blue R and safranin O, respectively, at a transmembrane pressure of 413 kPa in a hollow fiber membrane module coated for ten minutes with 0.75 wt % monomer concentrations of PEI and IPD. A very thin coating was achieved, although the reaction time was ten minutes, because of the high molecular weight of the amine monomer (PEI). The reactive monomer system of PEI-IPD produced a very smooth coating and this would reduce the membrane fouling.

Increase in the solvent flux and water flux in the coated flat film membranes was proportional to the applied transmembrane pressure in the studied pressure range. Solute rejection in the coated flat sheet membranes increased with increase in transmembrane pressure following the solution-diffusion model. The coating was able to withstand the applied pressure of 689 kPa and pore deformation was not observed at such a high pressure. The coating was also stable to continued exposure to toluene for the studied period of ten weeks. These results demonstrate that the polyamide coating on polypropylene has solvent resistance to alcohols and aromatic hydrocarbons.

Although the present disclosure is described with reference to exemplary embodiments and implementations thereof the present disclosure is not to be limited by or to such exemplary embodiments and/or implementations. Rather, the products and methods of the present disclosure are susceptible to various modifications, variations and/or enhancements without departing from the spirit or scope of the present disclosure. Accordingly, the present disclosure expressly encompasses all such modifications, variations and enhancements within its scope.

### LIST OF SYMBOLS

Aₘ membrane area, m² or cm²
J molar flux, mol/(m²*s)
nₚ number of pores for a membrane of given area
N volumetric flux, m³/(m²*s)
M molecular mass of the gas, kg/mol
ΔP gas or liquid pressure difference across a membrane, Pa or cm Hg
(Q/δ) gas permeance or liquid permeability, cm³(STP)/(cm²*sec*cm Hg) or cm³/(cm²*sec*cm Hg) respectively
R=8.31 J/(mol*K)
r₁ and r₀ average pore radii, (m or nm) of a selective layer and a bare membrane (the selective layer's support) respectively
Vᵢ permeate volumetric flow rate, cm³/s
W_{A} adhesion force, J/m² or J/mole
W_{AD} and W_{AP} dispersion and polar components of adhesion force, respectively, same units as for W_{A}
w mass flow rate of a gas, kg/s
δ₀, δ₁, δₒᵥₑᵣₐₗₗ thickness of a bare membrane, a selective layer or the thin membrane composite made out of them, bare membrane with a coating layer, m
εₛ membrane surface porosity, dimensionless
ε membrane bulk (volume) porosity, dimensionless
μ liquid viscosity, Pa*s
π tortuosity factor, dimensionless

We claim:

1. A method for producing a membrane, the method comprising:
a. providing a polyolefin structure;
b. hydrophilizing at least a portion of the polyolefin structure; and
c. coating the hydrophilized polyolefin structure through interfacial polymerization to form a substantially stable membrane element.

2. The method according to claim 1, wherein the polyolefin structure comprises at least one of:
(i) polypropylene, (ii) polyethylene, and (iii) poly(4-methyl-1-pentene).

3. The method according to claim 1, wherein the polyolefin structure takes the form of a film or fiber.

4. The method according to claim 3, wherein the fiber is a hollow fiber or a solid fiber.

5. The method according to claim 1, wherein the substantially stable membrane element is positioned in a substantially leak-proof module.

6. The method according to claim 1, wherein the hydrophilizing step includes exposure of the polyolefin structure to an oxidizing agent.

7. The method according to claim 6, wherein the oxidizing agent includes at least one of: (i) chromic acid, (ii) potassium permanganate, (iii) potassium persulfate, (iv) ozone and (v) hydrogen peroxide.

8. The method according to claim 6, wherein exposure to the oxidizing agent is part of an oxidizing technique selected from the group consisting of: (i) chemical oxidation, (ii) UV radiation oxidation, and (iii) plasma oxidation.

9. The method according to claim 1, further comprising applying a surface modification technique to the polyolefin structure.

10. The method according to claim 9, wherein the surface modification technique includes at least one of: (i) ion implantation, (ii) controlled ozonation, and (iii) covalent bonding of at least one hydrophilic moiety to the polyolefin structure using grafting.

11. The method according to claim 1, further comprising the step of treating the polyolefin structure with one or more wetting fluids prior to hydrophilization.

12. The method according to claim 11, wherein the one or more wetting fluids includes at least one of: (i) acetone, and (ii) an oxidation-resistant organic liquid miscible with water.

13. The method according to claim 1, further comprising the step of washing the polyolefin structure after one of: (i) hydrophilization (ii) interfacial polymerization, and (iii) both hydrophilization and interfacial polymerization.

14. The method according to claim 1, further comprising the step of storing the polyolefin structure in a storage fluid after hydrophilization and prior to interfacial polymerization.

15. The method according to claim 1, further comprising the step of soaking the polyolefin structure in poly(ethyleneimine) after hydrophilization and prior to interfacial polymerization.

16. The method according to claim 15, further comprising the steps of
a. draining the poly(ethyleneimine) from the polyolefin structure, and
b. securing the polyolefin structure relative to a polytetrafluoroethylene support.

17. The method according to claim 1, further comprising the step of treating the polyolefin structure with heat after interfacial polymerization.

18. The method according to claim 1, further comprising the step of incorporating one or more functional groups relative to the polyolefin structure.

19. A hydrophilic membrane produced according to the method of claim 1.

20. A membrane comprising:
a hydrophilic structure formed from a hydrophobic polyolefin support structure that is subjected to hydrophilization and coating through interfacial polymerization to provide hydrophilic functionality thereto.

21. The membrane according to claim 20, wherein the hydrophobic material is selected from the group consisting of polypropylene, polyethylene and poly(4-methyl-1-pentene).

22. The membrane according to claim 20, wherein the hydrophilic polyolefin structure is in the form of a film or fiber.

23. The membrane according to claim 22, wherein the fiber is a hollow fiber or a solid fiber.

24. The membrane according to claim 20, wherein the membrane is mounted in a module adapted for use in at least one of (i) ultrafiltration, (ii) nanofiltration, and (iii) low pressure reverse osmosis.

25. The membrane according to claim 20, further comprising at least one functional group bonded to the hydrophilic polyolefin structure through the interfacial polymerization.
